(19) United States
(12) Patent Application Publication
(10) Pub. No.: US 2026/0091313 A1
(43) Pub. Date: Apr. 2, 2026

(54) SYSTEMS AND METHODS FOR DISTRIBUTING PROCESSING TASKS FOR PROVIDING A MEDIA ASSET

(71) Applicant: Adeia Guides Inc., San Jose, CA (US)

(72) Inventors: Evgeny Kaminsky, Hollywood, FL (US); Dhananjay Lal, Englewood, CO (US); Reda Harb, Saint Petersburg, FL (US); Tao Chen, Palo Alto, CA (US); Aldis Sipolins, Somerville, MA (US)

(21) Appl. No.: 18/902,370

(22) Filed: Sep. 30, 2024

(51) Int. Cl. A63F 13/52; G06T 17/00

(52) U.S. Cl. CPC A63F 13/52; G06T 17/00

(57) ABSTRACT

The present disclosure is related to systems and methods for improving performance in rendering and providing content, such as, for example, by using a hybrid model that processes one or more server tasks on other connected high-performance devices. The systems and methods may receive a request for an item such as a 3D object from a mid-performance end device. The systems and methods may determine a list of devices available for processing tasks. The systems and methods select at least one device for at least one task. The systems and methods may merge the output of the at least one task into a merged result. The systems and methods may cause the merged result to be displayed on the mid-performance end device.

### BACKGROUND

The present disclosure is related to distributing processing tasks for providing a media asset.

### SUMMARY

Many applications, such as video gaming applications, utilize a significant amount of processing resources or computing power. The processing power and computing resources support captivating features, such as highly detailed imagery, that enhance the application. However, rendering power for an application is limited. For example, in console or PC gaming, the rendering power is generally limited to the finite processing power of the GPUs of these machines. Cloud gaming allows for external GPUs for processing, which may be larger and more numerous, increasing available rendering resources. Still, even cloud gaming has limitations. For one, it can be costly, in terms of consumption of computing and networking resources. Also, content continually outpaces rendering capability. As a result, processing power remains in short supply. One consequence of these circumstances is that often collaboration in an application becomes difficult. For example, users without access to high-performance devices, which may be relatively expensive, are unable to participate, despite the growing popularity of such application collaboration.

In one approach, game-stream architecture relies on powerful servers close to the client via edge computing, for instance, within the client's internet service provider (ISP) infrastructure. These servers utilize cloud gaming including high-end gaming hardware, encoding streams with advanced codecs like high efficiency video coding (HEVC), and then broadcasting them to clients. This setup allows clients lacking robust graphics processing units (GPUs) or central processing units (CPUs), but possessing high-bandwidth internet connections, to enjoy processing-intensive games. However, this approach often creates quality and delay constraints.

Additionally, such approach pose challenges when facilitating interactions or collaborative play among clients with varied capabilities. For example, integrating such diverse client environments in gaming or 3D modeling often benefits from hosting the games or workflows on centralized servers as cloud computing. However, this approach significantly increases server load (CPU/GPU usage) and internet traffic while allowing for content visualization only with moderate settings (e.g., 4K at 30 frames per second).

Given the drawbacks of the above-described approaches, there remains a need for an alternative distributed computing architecture to help enhance player interaction, decrease server burden, minimize game traffic, reduce latency, minimize device battery drain, and improve the overall quality of games or 3D content performance.

To help address these issues, techniques are disclosed for receiving, at a server from a client device, a request to access a media asset, wherein the server is configured to perform a first processing task related to causing the media asset to be displayed at the client device. A processing capacity and a latency associated with at least one available node are identified, wherein the at least one available node is in a different geographic location than the server. Based on the identified processing capacities and latencies, the at least one available node to perform at least one processing task related to the media asset is selected to assist the server in causing the media asset to be displayed at the client device. The selected at least one processing task is assigned to the selected at least one available node, wherein the first processing task creates a first processing result and the at least one processing task creates at least one processing result, and wherein the at least one processing task comprises rendering an interactive 3D object. The disclosed techniques may further cause the first processing result and the at least one processing result to be merged, at the client device, into a merged processing result corresponding to the media asset, and cause the merged processing result corresponding to the media asset to be displayed on the client device.

Such aspects enable, for example, allocating processing tasks to GPUs of available network nodes, to leverage the capabilities of average and high-performance clients to enhance player interaction, decrease server burden, minimize game traffic, reduce latency, and improve the overall quality of games or 3D content performance. Such aspects accommodate diverse client devices, from high-performance gaming rigs to more modest smartphones and tablets. By intelligently distributing rendering tasks based on each device's GPU/CPU capabilities and bandwidth availability, the disclosed techniques enhance user experience and optimize resource utilization across the network.

The system's ability to render workload according to device capabilities allows users to enjoy a high-quality gaming experience regardless of their hardware. The system leverages its robust processing power for high-performance devices to render complex 3D environments and effects locally. By offloading heavier rendering tasks to more capable devices or servers, the system delivers a visually appealing experience for mid- to low-performance devices, thus avoiding overloading weaker hardware and minimizing potential performance bottlenecks.

The system reduces unnecessary data transfers across the network by optimizing how and where the rendering processes occur—whether locally on a device or streamed from a server or another client device. For instance, streaming pre-rendered videos or using peer-to-peer sharing of rendered assets helps minimize bandwidth consumption compared to traditional cloud gaming models that rely solely on continuous streaming.

Service providers can benefit from reduced operational costs due to more efficient bandwidth usage and the potential to serve more users with the same server infrastructure. The scalability provided by adaptive split-rendering allows for a broader user base while maintaining the quality of service, thereby maximizing the return on investment in server and network infrastructure. The disclosed techniques optimize performance, responsiveness, and visual quality while minimizing hardware and network resource requirements. The disclosed techniques optimally distribute rendering and streaming tasks based on device capabilities and network conditions. They use adaptive streaming to minimize latency and maximize the visual quality and frame rate of 3D content. High-performance nodes are dynamically managed to ensure efficient gameplay and modeling experiences, making the system robust and scalable for varying user demands.

The present disclosure relates to an integrated system for assigning processing-heavy tasks to high-performance devices connected to lower-performance devices to enable the lower-performance devices to participate in complex interactive applications otherwise beyond their computing capacity. A central server may select and authorize high-performance devices from a list of available devices and assign tasks the application requires to the created network of devices. In some embodiments, the integrated system assigns tasks the application requires to each of the server, high-performance devices, and lower-performance devices according to computing power and latency.

The present disclosure describes systems and techniques for enabling high quality collaboration in 3D environments for devices with a wide range of capabilities. Unlike some approaches, the described techniques may distribute the total processing required for an application session among multiple high-performance devices based on a device's capability and availability. The system may receive a list of the required tasks and assign each task according to efficiency. The system, via a server or the high-performance devices themselves, may transmit the output of such tasks to lower-performance client devices otherwise incapable of such processing. As a result, lower-performance client devices are able to access collaborative applications at the same level as a high-performance client device.

The described systems and techniques may be implemented without requiring excessive or dedicated use of GPUs or bandwidth. In some embodiments, the effect is a network of high- and mid-performance devices interacting in a 3D environment. In such scenarios midperformance devices may handle less intensive processing, such as rendering background scenes, while high-performance devices may handle more intensive tasks, such as presentation of dynamic avatars. In some embodiments, the systems and techniques further incorporate low-performance devices. In such embodiments, little processing falls on the low-performance devices to complete. Instead, the system transfers input and output from high- and mid-performance devices to the low-performance devices, which may render resulting information for display. In some embodiments, the systems and techniques further incorporate a P2P (peer-to-peer) network to handle tasks. In some embodiments, the systems and techniques leverage a blend of high-performance and mid-performance client devices alongside a remote server setup.

The disclosed techniques enhance interactivity and performance in gaming and 3D modeling environments by effectively distributing computational and rendering tasks according to device capabilities. These embodiments optimize resource allocation across both server and devices, ensuring that high-quality gaming and collaborative 3D modeling are accessible on a broad spectrum of hardware, enhancing overall performance, reducing response times, and achieving superior visual fidelity.

In some embodiments, the disclosed techniques maintain functionality to server-client gaming architectures when only low-complexity nodes are involved, with all rendering handled by the server. However, introducing at least one client capable of rendering content locally significantly enhances system efficiency. This setup reduces the rendering load on the server, allowing it to deliver less complex visual content—such as background elements—at a reduced bit rate. Static and predictable content compresses more effectively, benefiting from the newest video coding technologies like the VVC (Versatile Video Coding) standard and client-side quality enhancement technologies like DLSS (Deep Learning Super Sampling). Adding a high-performance client device that can partially handle the server's rendering tasks transforms the system. Such high-performance nodes can directly stream to other clients via P2P protocols like WebRTC, drastically cutting response times and server traffic. This capability makes the service more appealing for providers seeking to offload network and server load and enhances the gaming experience for players with high-performance devices. They can interact seamlessly with users on less capable devices, promoting inclusivity. Furthermore, this system open avenues for monetization. High-performance clients could be incentivized to share their resources during gameplay or even while idle, potentially earning rewards or paying reduced service fees. This model optimizes resource use across the network and introduces a profitable ecosystem where all participants can benefit from contributing computing power and internet upload bandwidth.

In some embodiments, the at least one available node comprises the client device. In some embodiments, the processing capacity comprises a graphics processing capability of the at least one available node, and selecting the client device is based on determining that the graphics processing capability of the client device exceeds a threshold processing capability. In some embodiments, the server is a first server, and the at least one available node comprises a second server at a different geographic location than the first server.

In some embodiments, the media asset is a video game, and the disclosed techniques further comprise determining that a current portion of the video game being provided by the server to the client device is associated with a level of interactivity that is below a threshold, and, based on the determining, performing the assigning of the at least one processing task to the at least one available node during the current portion of the video game associated with the level of interactivity.

In some embodiments, the disclosed techniques identify a plurality of 3D objects in the media asset; determine a first subset of the plurality of 3D objects are likely to interact amongst each other but not likely to interact with a second subset of the plurality of 3D objects; and determine that the second subset of the plurality of 3D objects are likely to interact amongst each other but not likely to interact with the first subset of the plurality of 3D objects. In some embodiments, assigning the selected at least one processing task comprises causing the at least one node to render the first subset of the plurality of 3D objects to the at least one node, and rendering, by the server, the second subset of the plurality of 3D objects.

In some embodiments, the disclosed techniques determine a first subset of the plurality of 3D objects that appear in the media asset for more than a threshold period of time, and determine a second subset of the plurality of 3D objects that appear in the media asset for less than the threshold period of time. Assigning the selected at least one processing task may comprise causing the client device to render the first subset of the plurality of 3D objects, and rendering, by the server, the second subset of the plurality of 3D objects.

In some embodiments, the at least one available node is the client device, and wherein the media asset is a video game comprising a background and an avatar of a user associated with the client device, wherein assigning the selected at least one processing task comprises causing the client device to render the avatar of the video game, and rendering, by the server, the background of the video game.

In some embodiments, the rendering of the interactive 3D object is performed at each of a first available node and a second available node of the selected at least one node, to create redundancy with respect to the rendering of the interactive 3D object. In some embodiments, at a first time, the merged processing result comprises the rendering performed by the first available node. The disclosed techniques may further comprise determining, at a second time, that the first available node is no longer available to perform the rendering, and, based on the determining, may cause the merged processing result to include the rendering performed by the second available node.

In some embodiments, the at least one node comprises the client device, and the disclosed techniques may further comprise causing the client device to download a 3D model associated with the media asset, and causing the client device to transmit the 3D model to another client device accessing the media asset, wherein the processing capacity of the client device is greater than a processing capacity of the other device.

In some embodiments, the disclosed techniques may cause the client device to generate a value indicative of a reference time at the client device, and receive, at the server, the value, wherein the value is transmitted to the server, and to the at least one available node, based on a user input received at the client device. The disclosed techniques may embed, at the server, the value in a first portion of the media asset generated by a processing task performed by the server, and cause the at least one available node to embed the value in a second portion of the media asset generated by the at least one processing task assigned to the at least one available node, wherein the client device synchronizes display of the first portion and the second portion based on the values embedded in the first and second portions.

In some embodiments, the disclosed techniques may authenticate each node in the selection of nodes, wherein authenticating each node in the selection of nodes comprises assigning a trust level to each node in the selection of nodes and wherein assigning the at least one processing task is further based on the assigned trust levels. In some embodiments, the server is associated with a cloud service, and assigning the trust level comprises determining whether each of a plurality of nodes is external to the cloud service or is included in the cloud service, and assigning each node that is external to the network to one or more trust levels that are lower than trust levels of each node that is included in the cloud service.

In some embodiments, the disclosed techniques may determine that the at least one processing task comprises a task related to a sensitive data, and, based on determining that the at least one processing task comprises a processing task related to a sensitive data, causing a node that is included in the network, that has a relatively higher assigned trust level, to perform the processing task related to the sensitive data, instead of a node that is external to the network and having a relatively lower assigned trust level. In some embodiments, the disclosed techniques may cause one or more of the first processing result or the at least one processing result to be transferred directly between nodes in the selection of nodes.

In some embodiments, the disclosed techniques may identify a plurality of 3D portions in the media asset, wherein the plurality of 3D portions comprise at least one of 3D objects or 3D scene elements, and determine a first likelihood of a first subset of the plurality of 3D portions to interact with each other (e.g., based on a scene graph which may be, for example, in an XML format). The disclosed techniques may determine a second likelihood of the first subset of the plurality of 3D portions to interact with a second subset of the plurality of 3D portions, wherein the second likelihood is a non-zero likelihood. The disclosed techniques may, based at least in part on determining that the first likelihood exceeds a threshold and that the second likelihood does not exceed the threshold, maintain a dependency between the first subset and the second subset and removing a dependency (e.g., a weak dependency) between the first subset and the second subset. The disclosed techniques may cause the at least one node to render the first subset of the plurality of 3D portions, and render, by the server, the second subset of the plurality of 3D portions. For example, the disclosed techniques may identify via the scene graph that there is weak dependency between two sets of rendering tasks, and dynamically determine to break the weak dependency, making the sets mutually independent, and may select one or more graphics processing techniques before dispatching those sets of tasks to separate nodes.

### BRIEF DESCRIPTION OF THE DRAWINGS

FIG. 1 shows an illustrative system for selecting a node to be assigned a processing task, in accordance with some embodiments of this disclosure.

FIG. 2 shows an illustrative example of dividing processing tasks between nodes, in accordance with some embodiments of the present disclosure

FIG. 3 is a flowchart of an example process, in accordance with some embodiments of the present disclosure;

FIG. 4 shows an example latency test process, in accordance with some embodiments of the present disclosure;

FIG. 5 shows an example time synchronization process, in accordance with some embodiments of the present disclosure;

FIG. 6 shows an example workflow, in accordance with some embodiments of the present disclosure;

FIG. 7 shows an example workflow, in accordance with some embodiments of the present disclosure;

FIG. 8 shows an example workflow, in accordance with some embodiments of the present disclosure;

FIG. 9 shows an example workflow, in accordance with some embodiments of the present disclosure;

FIG. 10 shows an example workflow, in accordance with some embodiments of this disclosure.

FIGS. 11-12 show illustrative devices, systems, servers, and related hardware for selecting a node to be assigned a processing task, in accordance with some embodiments of this disclosure; and

FIG. 13 is an illustrative flowchart of a process for selecting a node to be assigned a processing task, in accordance with some embodiments of this disclosure.

### DETAILED DESCRIPTION

The present disclosure describes, at least in part, systems and methods for facilitating performance of processing-intensive applications by dividing processing power among connected devices.

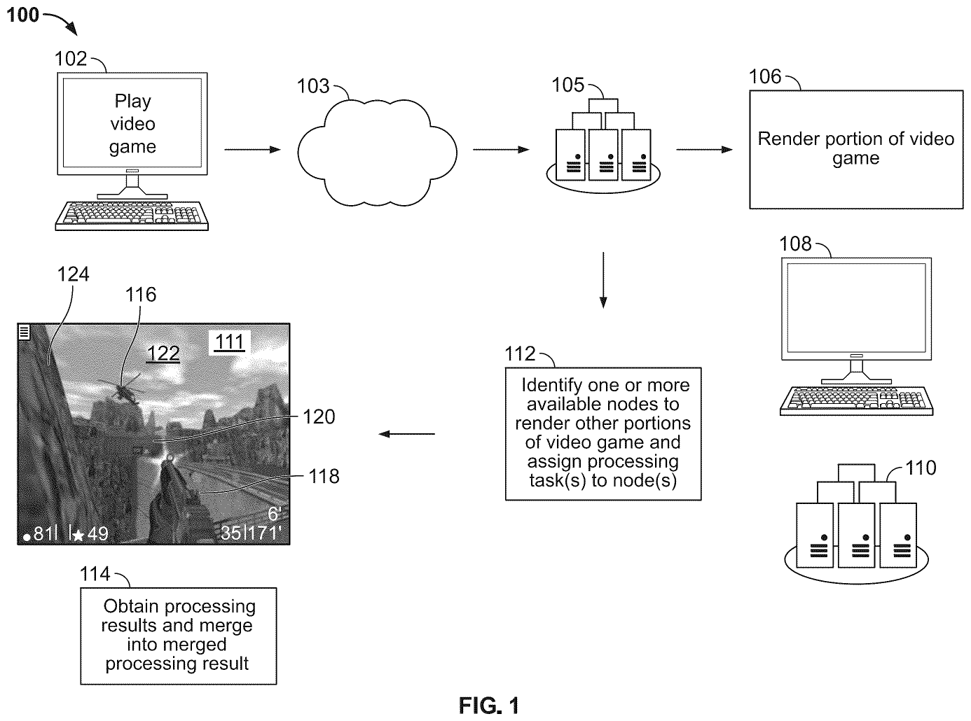

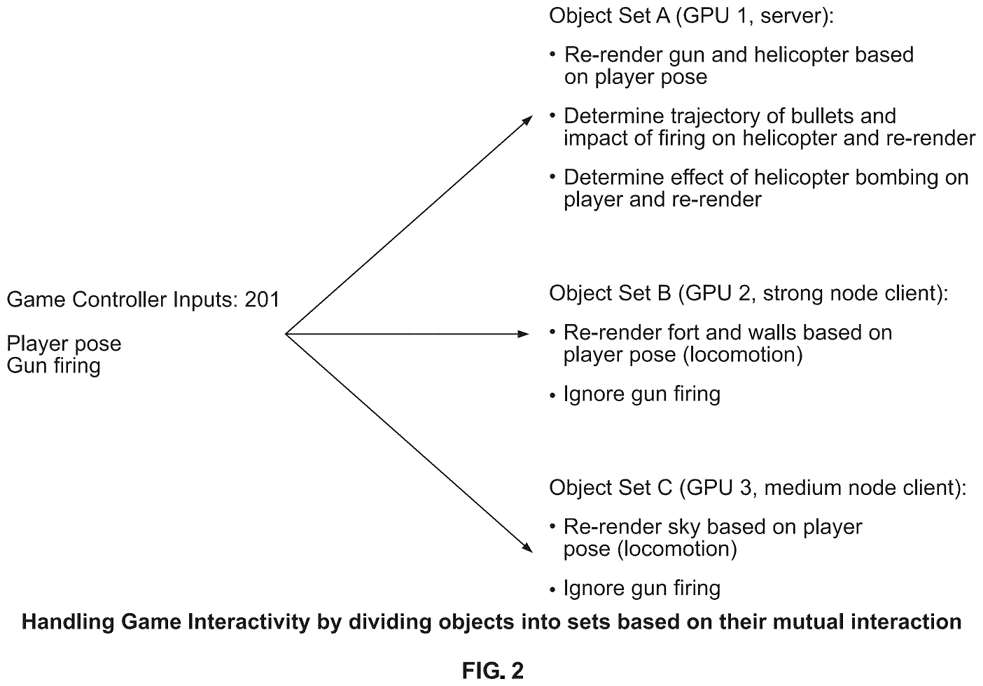

FIG. 1 shows an illustrative system for selecting a node to be assigned a processing task, in accordance with some embodiments of this disclosure. The technique shown in FIGS. 1-11 may be implemented at least in part by hybrid system 100, which also may be referred to as an adaptive split-rendering hybrid system. In some embodiments, the architecture of hybrid system 100 is built around integrating high-performance, mid-performance, and relatively lower-performance nodes with a high-performance computing server in the cloud. Hybrid system 100, in the example shown in FIG. 1, may comprise client device 102, server 105, client device 108, server 110, and/or any other suitable devices, servers, databases, and/or other components.

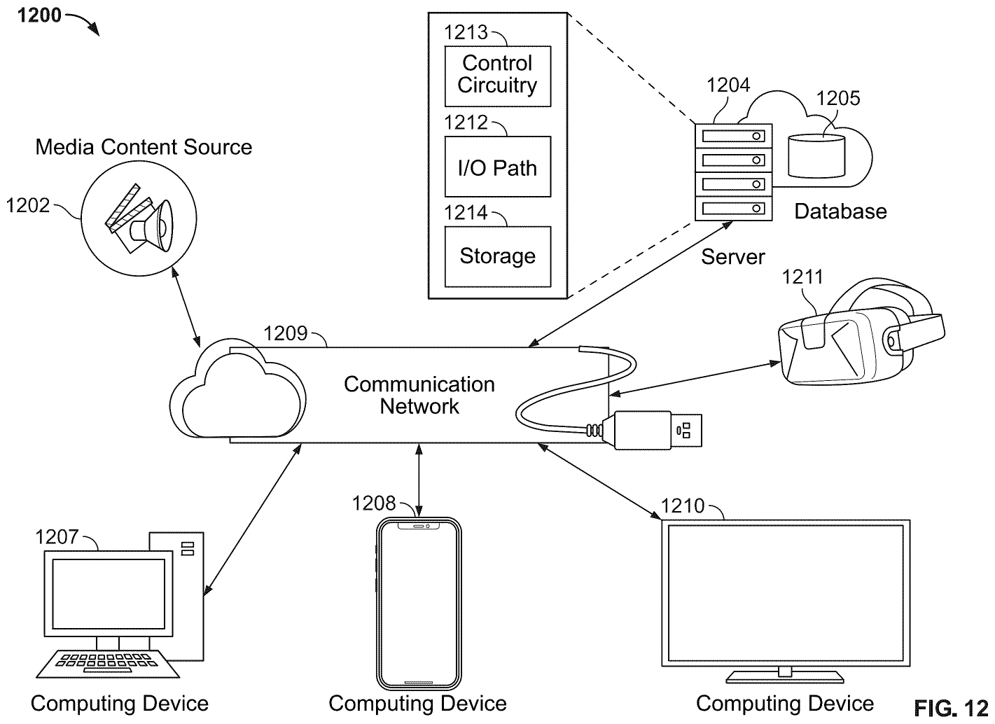

Hybrid system 100 may be executed at least in part at one or more client devices (e.g., client devices 102 and 108) and/or at one or more remote servers (e.g., media content source 1202 and/or server 1204 of FIG. 12) and/or at any other suitable computing device(s). Hybrid system 100 may be configured to perform the functionalities (or one or more portions thereof) described herein. In some embodiments, hybrid system 100 may comprise or be incorporated as part of any suitable application or software. For example, hybrid system 100 may comprise or be implemented in conjunction with one or more extended XR applications; content delivery network (CDN) applications; network management applications; video game applications including cloud gaming applications, one or more image or video capturing and/or editing applications; one or more image, video and/or textual acquisition, recognition and/or processing applications; one or more content creation applications; one or more machine learning models or artificial intelligence models; one or more streaming media applications; or any other suitable application(s) or any combination thereof; and/or may comprise or employ any suitable number of displays; sensors or devices such as those described in FIGS. 1-13; or any other suitable software and/or hardware components; or any combination thereof.

XR may be understood as virtual reality (VR), augmented reality (AR) or mixed reality (MR) technologies, or any suitable combination thereof. VR systems may project images to generate a 3Denvironment to fully immerse (e.g., giving the user a sense of being in an environment) or partially immerse (e.g., giving the user the sense of looking at an environment) users in a three-dimensional, computer-generated environment. Such environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world or the real world is otherwise connected to virtual objects.

As shown in FIG. 1, server 105 receives a request, over network 103, from client device 102 to access a media asset, e.g., the video game shown at 111, or any other suitable media asset (e.g., high-performance gaming; on-demand or live content; an XR asset, such as, for example, brain surgery simulations (or other suitable education or professional training environments); or any other suitable media asset utilizing low latency or ultra-low latency, e.g., over a network). Video game 111 may be any suitable type of video game (e.g., a role-playing game (RPG), an action video game, a first person shooter (FPS) video game, a sports video game, or any other suitable type of video game, or any suitable combination thereof) provided via any suitable device 102 and/or 108 platform (e.g., via a game console, smartphone application, tablet, desktop, Internet, or any other suitable platform, or any suitable combination thereof). Video game 111 may be a single player or multi-player game. In some embodiments, client device 102 (and/or client device 108) may be, for example, a headset; a mobile device such as, for example, a smartphone or tablet; a video game console; a laptop computer; a personal computer; a desktop computer; a smart television; a smart watch or wearable device; smart glasses; an XR head-mounted display (HMD); a stereoscopic display; a wearable camera; XR glasses; XR goggles; a near-eye display device; or any other suitable user equipment or device capable of connecting to the Internet or other suitable network; or any combination thereof.

Server 105 may comprise one or more servers located at a first geographic location (e.g., a datacenter in New York), and may comprise one or more edge servers, origin servers, or any other suitable servers and/or databases of a content delivery network (CDN) and/or any other suitable cloud server provider or ISP. Server 105 may be configured to process or render at least a portion of video game 111, as shown at 106. Server(s) 105 that receive that request to access video game 111 may be the same or different from server(s) 105 used to process or render the at least a portion of video game 111.

As used herein, unless otherwise stated, rendering should generally be understood to refer to rendering performed at least in part by a GPU, as opposed to more rudimentary, hardware-agnostic rendering, e.g., raster scanning. GPU architectures inherently employ parallel processing for rendering, such as, for example, generating real-time graphics for a video game.

In some embodiments, server 105, rather than performing all of the processing tasks for providing video game 111 to client device 102, may distribute one or more of such processing tasks to one or more nodes, e.g., node 102 itself, and/or nodes 108 or 110. For example, at 112, hybrid system 100 may identify one or more available nodes (e.g., 108 and/or 110) to render other portions of the video game and assign processing task(s) to node(s). Such nodes may be identified based at least in part on a processing capacity of the respective node and/or a latency associated with the respective node (e.g., based on current network conditions and/or device capabilities). For example, based on one or more of such device capabilities (e.g., hardware such as, for example, a GPU or CPU, or any other suitable hardware, software, or current conditions of the device or network), hybrid system 100 may classify a node or device as a high-performance node, a mid-performance node, or a low-performance node. Hybrid system 100 may identify video game 111 as an application or media asset that demands considerable processing power (e.g., exceeding a threshold amount of processing power) and/or bandwidth (e.g., exceeding a threshold) and/or other parameters.

In some embodiments, hybrid system 100 determines one or more processing tasks to be performed to enable providing video game 111. Hybrid system 100 may determine a list of connected devices and their capabilities. For example, in the embodiment shown in FIG. 1 the hybrid system 100 connects to devices 102, 105, 108, and 110. Based on the device information, hybrid system 100 selects devices for task assignments and assigns tasks from the required tasks to selected connected devices. For example, in the embodiment shown in FIG. 1 the hybrid system 100 determines that devices 108 and 110 are high-performance devices. High-performance devices are any devices capable of completing complex processing tasks. Examples of high-performance devices include VR headsets and gaming computers, for example. The hybrid system 100 then selects devices 108 and 110 and assigns the devices 104 and 106 complex tasks that require high-performance processors. Similarly, server 105 may be a high-performance server. In some embodiments, server 105 and devices 108 and 110 each complete the assigned tasks. The hybrid system 100 may also determine that device 102 is a low- or mid-performance device and assign to device 102 simple tasks that require less processing power.

In some embodiments, hybrid system 100 may identify client device 108 (e.g., located at a different geographic location than client device 102) and/or server 110 (e.g., implemented in a similar manner as server 105, except located at a different datacenter in a different geographic location than server 105) as high-performance nodes. For example, server 110 may be located in a datacenter in, e.g., California, whereas server 105 may be located in a datacenter in, e.g., New York. Alternatively, in some embodiments, server 105 and server 110 may be located in the same datacenter, e.g., as separate servers or as part of a same physical server (e.g., instances in a virtual server architecture).

In some embodiments, server 105 and/or client device 108 may be nodes that function as server assistants, helping to manage and optimize server operations. High-performance nodes with high-performance GPUs can render games and complex 3D models and environments. At the same time, devices with mid-performance capabilities can render some 3D objects that are less complex and rely on high-performance nodes to receive streams that represent select views of the rendered 3D objects that would otherwise be challenging for the medium nodes with mid-performance capabilities to render. In some embodiments, the streams may be sent directly between nodes, e.g., via Web Real-Time Communication (RTC) protocol. In some embodiments, the mid-performance nodes still need a server to render the game environment. These mid-performance nodes may combine the content generated or rendered by, e.g., server 105, with the content received from other high-performance nodes, and/or with content the mid-performance node can render itself, to generate complete content (e.g., a merged processing result for video game 111 provided for display at client device 102, as shown at 114).

In some embodiments, hybrid system 100 uses computer vision (CV) to combine processing results at client device 102 (e.g., a mid-performance node), facilitated by CV algorithms, which may combine self-rendered elements and streams from both the server and high-performance nodes to ensure fluid gameplay or workspace interaction. In some embodiments, when a high-performance node wants to serve multiple machines/players, it sends a scene graph of the 3D objects to a server (e.g., using QUIC (quick UDP Internet connection). The server then generates customized viewpoints for every machine and merges them with the content that is rendered to deliver them to the clients (e.g., via WebRTC).

In some embodiments, for enabling interactivity, and when distributing processing tasks to selected nodes, hybrid system 100, e.g., via server 105, may divide objects or other portions of an environment to be rendered (e.g., helicopter 116, weapon 118, fort 120, sky 122, cliffs or walls 124) into mutually exclusive sets from the point of view of interactivity. In some embodiments, 3D portions of a scene, e.g., fort 120, sky 122, cliffs or walls 124 may be considered 3D objects, or 3D portions of a scene or environment, as well as 3D objects (e.g., helicopter 116) may be referred to as 3D portions. For example, objects rendered by server may have mutual interactivity with each other but not with other objects. This holds true also for strong nodes and medium nodes. The more sets that objects in the scene graph can be divided into that interact with themselves but not with other objects, the more that rendering can be distributed across nodes. This may be useful because, once rendering and encoding of processing results is performed, semantic understanding of relationships between objects may be lost. Since a player game input is directed appropriately to affect the scene, any user input may be sent (broadcast) to each of the rendering nodes, so they can each individually decide how their respective renderings should change due to the input. This may provide server 105 with some constraints in how to divide the compute power.

The hybrid system 100 may separate certain dependent tasks if it determines only a weak dependency between the tasks. For example, the scene of video game 111 in FIG. 1 shows a fighting scene of a player with a weapon 118. The player is walking toward an outdoor fort. The fort 120 and walls 124 may be rendered highly photo-realistically with shadows using ray-tracing. The shadow of the player may still be developed using baked-in lighting, however. Therefore, the walls, fort, and player, although somewhat connected, are not necessarily dependent on one another. The image of the sky 122, by contrast, is independent, having no impact on objects around it. By removing a weak dependency, here, using ray-tracing to develop a fast-moving player's shadow, albeit at the cost of ultra-photorealism, server 105 can allocate object rendering across multiple GPUs and assign the shadow of the player to one device and shadows of the fort and walls to another.

FIG. 2 shows an illustrative example of dividing processing tasks as between, e.g., server 105, server 108, and client device 102. For example, a first object set may comprise the player character with weapon 118 and helicopter 116, as such objects may modify each other (e.g., by firing bullets at each other, which may damage helicopter 116 and/or wound the player's character), e.g., rendered on server 105. The second object set may include fort 120 and walls 124 (which may not be impacted by the bullets in the first object set, and/or minimally impacted by any other objects during gameplay, and thus placed in a different object set), rendered in high photo-realism with ray tracing, e.g., rendered on a high-performance client, such as, for example, node 108 or 110; and the third object set may include sky 122, e.g., rendered on a medium node client, such as, for example, client node 102.

As shown in FIG. 2, hybrid system 100 may monitor user inputs such as a player pose of the video game character holding weapon 118 of FIG. 1 and firing of weapon 118 of FIG. 1. As part of object set A, the hybrid system 100 may cause, e.g., a GPU of server 105 to re-render weapon 118 and helicopter 116 based on the player pose monitored at 201, determine a trajectory of bullets and impact of firing on helicopter and re-render accordingly, and determine an effect of helicopter bombing or firing at the player's video game character, and re-render accordingly. As part of object set B, the hybrid system 100 may cause, e.g., a GPU of server 110 to re-render fort 120 and walls 124 based on player pose (locomotion), and ignore the gun firing, since such firing may have no impact on an appearance of fort 120 or walls 124, as per the video game programmed rules. As part of object set C, the hybrid system 100 may cause, e.g., a GPU of client device 102 or 108 to render sky 122 based on player pose (locomotion), and ignore the gun firing, since such firing may have no impact on an appearance of sky 122, as per the video game programmed rules.

To specify dependencies in interactivity, as well as their intensity (weak/strong, etc.), metadata may be manually (e.g., by a game developer) or automatically associated with objects to indicate which objects can belong within the same set (strong/weak interaction with each other) and insert it into the scene graph (e.g., using XML (extensible markup language)). The hybrid system 100 reads these dependencies and determines which objects can be rendered on the same GPU. The hybrid system 100, in some embodiments, splits the global scene-graph (logical/semantic representation of the scene with objects) and sends only the relevant scene graph elements to each device (e.g., strong node or medium node client). In some embodiments, different dependency sets are simulated and rendered on separate nodes.

The hybrid system 100, in some embodiments, considers shared components of different 3D objects to more effectively group objects, such as fort 120 or walls 124, weapon 118, and helicopter 116, into sets. The hybrid system 100 may retrieve 3D object components from the scene graph and assign objects to sets based on shared values. Such a method may improve the performance of the hybrid system 100 and reduce the number of choices the developer needs to make. Three likely component candidates are collision layers, draw call batches, and GPU instance groups.

Collision layers help manage what can collide with what within a video game or other digital environment. A developer may assign 3D objects to different collision layers based on their desired functionality, to minimize required computing power. In one example, a developer may use a floor collision layer to prevent characters from falling through the floor and a wall layer to prevent objects from passing through walls. The player may collide with both, but a flying bird would only collide with a wall, saving the computing power that would have been needed to check for birds colliding with the floor. The hybrid system 100 may retrieve vectors containing collision layer assignments and use them to group game objects into sets.

Draw call batches help present visual representations of an object. To represent an object on a display, a draw call may be issued to the graphics API (application programming interface) (e.g., OpenGL, Direct3D). Draw calls are often computationally expensive, with the graphics API doing significant work for every draw call. Batching groups allows for better performance, as the hybrid system 100 may render a giant mesh instead of many small meshes. The hybrid system 100 may then perform a series of fast draw calls for each statically batched mesh. The hybrid system 100 may retrieve draw call batch IDs and use them to group game objects into sets.

GPU instancing is a draw call optimization method that renders multiple copies of a mesh with the same material (e.g., an instance) in a single draw call. This technique is useful for presenting things that appear multiple times in a scene (e.g., trees, enemies). GPU instancing renders identical meshes in the same draw call and enables the developer to vary properties such as color or scale. The hybrid system 100 may retrieve GPU instance group IDs and use them to group game objects into sets.

In some embodiments, the processing result of the processing tasks performed by server 105, client node 108, and/or server 110 may be provided over a network to server 105, or directly to client device 102, to merge the processing results into a combined output to generate video game 111 at client device 102. In some embodiments, device 102 performs rendering and/or processing of one or more processing tasks for video game 111 locally.

In some embodiments, hybrid system 100, in which multiple devices render content and directly stream to other devices, reduces the rendering load on the server 105, allowing it to deliver less complex visual content, such as background elements of a game, at a reduced bit rate, reducing response times and server traffic. Similarly, because the processing tasks are not assigned to one device alone, and are shared among many devices, enhanced processing power is available to permit video game 111 to run smoothly without delay on device 102. Static and predictable content video game 111 compresses more effectively, benefitting from both the newest video coding technologies like versatile video coding (VVC) and client-side quality enhancement technologies like DLSS. Adding high-performance devices, such as devices 108 and 110, that can partially handle the server's 105 rendering tasks and can directly stream to other devices such as device 102 via P2P protocols like WebRTC, may further cut response times and server traffic.

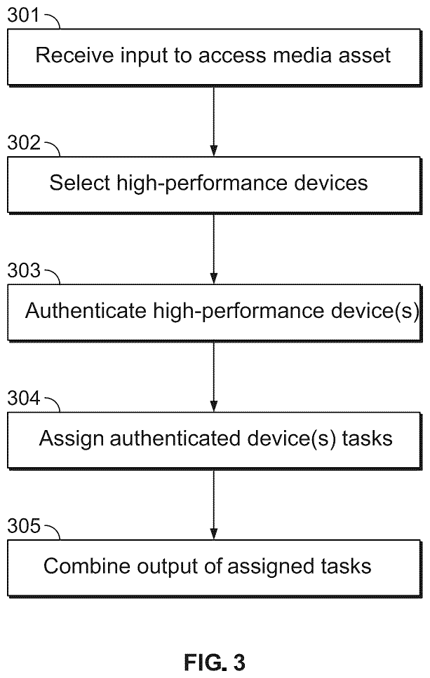

FIG. 3 is a flowchart of a sequence diagram for the hybrid system 100, in accordance with some embodiments of this disclosure. At step 301, an application or media asset, such as a video game, is accessed (e.g., over network 103 of FIG. 1) on a device such as device 102 based on receiving input requesting output of the application. At step 302, hybrid system 100 determines a list of available devices and selects one or more high-performance devices 108, 110 for complex processing, as discussed in relation to FIG. 1. The hybrid system 100 may also designate back-up nodes during the high-performance device selection process. Such processes may include network probing to estimate latency.

At step 303, the hybrid system 100 authenticates selected high-performance devices 108, 110. In some embodiments, selection of a high-performance device 108, 110 can occur prior to the application session or during the session, such as when a client device, such as device 102, and the server 105 are the only entities initially involved in the session. Still the hybrid system 100 may authenticate the high-performance device 108, 110 and adds it to the session later (e.g., during a period of no interactivity such as when a game's cutscene is playing, etc.).

In some embodiments, the hybrid system 100 designates a trust level to a selected high-performance device 108, 110. For example, any high-performance device 108, 110 outside of a centralized cloud rendering workflow (e.g., associated with server 105, such as any device or server that is not part of Azure or Amazon Web Services) may be designated with a different trust level than the servers or devices within the network. While there may be admittance and authentication criteria to admit new high-performance devices 108, 110 to assist in rendering some content on behalf of the server, in some embodiments, there may be scenarios where specific content associated with specific interactive elements is, by design, only handled by a trusted device in a designated centralized network. An example of such content associated with an interactive element is a financial transaction in a 3D environment (e.g., a purchase from a VR mall). In another example, the hybrid system may not assign a P2P client tasks that affect a game outcome. The server 105 or larger hybrid system 100 may enforce policy across the network of available rendering GPUs to ensure adherence to this constraint.

At step 304, the integrated system 100 assigns authenticated high-performance devices 108, 110 in the network tasks, and server 105 and high-performance devices 108 and 110, complete their assigned tasks. In some embodiments, multiple high-performance devices 108, 110 are assigned different tasks based on the session (e.g., gaming, exploring VR worlds, etc.). In some embodiments, after the hybrid system 100 selects a candidate list of high-performance devices 108, 110, it receives a list of tasks that the application requires to fully render content for a client device, such as device 102. In some embodiments, this list is based on an existing template. The hybrid system 100 then assigns at least one task to each selected high-performance device 108, 110. In some embodiments, task assignment occurs during the authentication and/or admittance phase. The hybrid system 100 may signal such assignments by a cloud-service or the client device in some embodiments. At step 305, the hybrid system 100 combines the outputs of the assigned tasks. For example, in a scenario where different devices process and render portions of a scene, the different portions may be combined. This approach reduces bandwidth for high-performance devices 108, 110 to send content to the server 105 since the devices 108, 110 may only send a portion of the overall scene. At the same time, synchronization techniques described herein may be used between multiple streams and the video. In some circumstances, content may be compressed more effectively than handling multiple separate streams.

In some embodiments, the server 105 is responsible for assuming the responsibility of any high-performance device 108, 110 that becomes decommissioned (e.g., is no longer available). In some embodiments, the hybrid system 100 periodically collects telemetry data and analyzes it during the application session. This process allows an QoS-service to rate the health of the session as well as the participating high-performance devices 108, 110. In some embodiments, a high-performance device 108, 110 may signal its future unavailability (e.g., going offline in x-minutes). Such information allows for replacing the device (e.g., with a back-up) or having the server 105 assume the tasks of that device. In some embodiments, the hybrid system 100 may enable or disable features based on the availability of high-performance devices 108, 1106. For example, if high-performance devices 108, 110 are unavailable to generate portion of a video, or if the hybrid system 100 experiences limited bandwidth, the hybrid system 100 may enable 4K rendering but disable 16K to reduce processing time and improve performance. In some embodiments, hybrid system 100 may frame an optimization problem for object rendering allocation across multiple GPUs. It reads the scene graph to create possibilities of objects that may be rendered together on the same GPU. It then identifies all the GPUs in its network (proximity) that can perform the rendering and applies the trust and time sync constraint to further narrow down its possibilities.

In some embodiments, high-performance devices 108, 110 are outfitted with high-performance GPUs, enabling them to render entire games or 3D working environments for themselves and specific 3D objects for the benefit of the group, targeting mid-performance devices 102. These high-performance devices 108, 110 capture and distribute select views of these specially rendered 3D objects through an alpha channel, which controls the transparency of each pixel, determining how opaque or transparent it will be. This feature enables 3D objects to merge smoothly with the background elements in a project. When an image or video frame that contains an alpha channel is imported, the hybrid system 100 automatically detects this feature, allowing the media to integrate with other elements on the canvas by adjusting its transparency.

Mid-performance devices 102, such as mobile devices equipped with mid-performance GPUs (smartphones, tablets, and XR devices like Apple Vision Pro), can also, in some embodiments, render entire games or individual 3D objects. When operating at maximum CPU/GPU capacity, mid-performance devices 102 produce lower output quality (resolution, FPS (frames per second), etc.) compared to high-performance devices 108, 110 due to their CPU/GPU limitations. This high demand on the processors of mid-performance device 102 leads to increased power consumption and shorter battery life as well. However, these mid-performance devices 102 can render smaller on-screen 3D objects with less complex geometries and simpler textures with minimal resource usage, using significantly less battery power and allowing prolonged gameplay or 3D collaboration with quality comparable to high-performance devices. Some embodiments take advantage of this ability and assign these minimal resource tasks to the mid-performance devices 102. In some embodiments, as with high-performance devices 108, 110, the mid-performance devices 102 may transmit the product of these tasks to the other devices.

Furthermore, local rendering on mid-performance devices 102 minimizes latency during interaction, reducing server GPU/CPU load. When the server 105 renders an environment of a 3D application technologies like DLSS can efficiently enhance resolution and frame rates, optimizing server performance and maintaining client-side quality. Broadcasting just the environment, for example, a football field without players, significantly reduces the bitrate required for processing without sacrificing quality. These environments may also be more heavily compressed, saving bandwidth, because movement is limited to global actions. Such 3D videos can be transmitted at lower FPS (frames per second) rates or resolutions and effectively enhanced to full quality using algorithms like DLSS. Some embodiments take advantage of these techniques to improve server load.

In some embodiments, mid-performance devices 102 are responsible for rendering some 3D objects needed for the application session, such as gaming or collaborative projects. In some embodiments, these devices 102 receive streams that capture the foreground 3D objects via the alpha channel. High-performance devices 108, 110 may send these streams directly from strong nodes to mid-performance devices 102 using the WebRTC protocol, bypassing the server 105 to minimize latency. The 3D environment, rendered on the server 105, and certain 3D objects pre-rendered on the mid-performance devices 102, may be seamlessly integrated into a final output using a CV algorithm, which combines self-rendered elements and streams from both the server and strong nodes to ensure fluid gameplay or workspace interaction. Addressing synchronization complexities across different devices and streams, particularly at high frame rates, can be established by deploying advanced synchronization protocols and buffer management strategies.

Such synchronization protocols ensure the temporal alignment of mixed-resolution content for seamless integration of locally rendered objects with streamed video. Additionally, predictive algorithms compensate for potential latency differences, maintaining the visual coherence of all scene elements in real-time interactions. This approach enables effective collaboration between devices of different capabilities by significantly reducing delays or response times, decreasing server traffic, and enhancing the overall quality. Consequently, the experience of participating in a collaborative application, such as games or collaborative projects, on mid-performance devices 102 may closely mirror that on high-performance devices 108, with minimal perceptible difference in performance or interaction quality.

In some embodiments, the hybrid system includes just two types of machines-a high-performance computing (HPC) server, such as server 105, and a mid-performance device, such as device 102. In some embodiments, combining content streamed from the HPC server with locally rendered content employs techniques to maintain scene integrity, especially regarding light interactions. The HPC server may render and stream the entire environment, which may include, for example, static backgrounds and more prominent environmental elements that require substantial computing power, to the mid-performance device 102. The mid-performance device 102 meanwhile may render dynamic objects such as any characters, non-playable characters, or vehicles. In some embodiments, the HPC server may send comprehensive scene data, such as textures, environmental geometry, and global lighting information, to the mid-performance device 102. This transmission ensures the mid-performance device 102 has all the details to render dynamic objects accurately, maintaining visual consistency across the environment. In some embodiments, the HPC server may handle environmental lighting for static elements as well, while the mid-performance device manages dynamic objects. This method uses the HPC server's computing power to establish global lighting, which the mid-performance device then adapts to render dynamic objects accurately, ensuring that lighting interactions remain realistic and consistent with the overall scene.

Some embodiments further include careful synchronization, as discussed in more detail below. This step seamlessly integrates dynamically rendered objects into the server-rendered environment. The hybrid system 100, in some embodiments, ensures synchronization and alignment by performing primary compositing server-side and allowing the mid-performance device 102 to add dynamic elements, which is crucial for avoiding visual discrepancies and maintaining a coherent scene. The hybrid system 100, in some embodiments, further includes real-time management of environmental adjustments and the devices' 102, 108, 110 dynamic rendering response. This dynamic interaction ensures that changes in the environment, such as moving shadows or light shifts, are reflected accurately on static and dynamic elements, fostering a responsive and immersive experience. The hybrid system 100 provides a robust system architecture that maximizes the rendering capabilities of both the server and the client, and, leveraging the strengths of each machine type, optimizes resource use and ensures that the game environment's static and dynamic elements are rendered with high-quality, coherent lighting and shadow.

Hybrid system 100 may involve the collaboration of multiple machines, e.g., client device 102 and server 105, and such collaboration may be facilitated at least in part by synchronizing the devices. In some embodiments, the hybrid system 100 relies on threshold latency budgets to bound the interactive experience. That is, with multiple rendering nodes, nodes may be selected such that the sum total of the rendering and encoding/decoding time and network latency to send a frame of a media asset is less than a threshold value. In some embodiments, the hybrid system 100 measures latencies to multiple potential nodes and chooses a high-performance node, such as 108 and/or 110, with a frame delivery latency similar to a high-performance server (e.g., server 105 of FIG. 1).

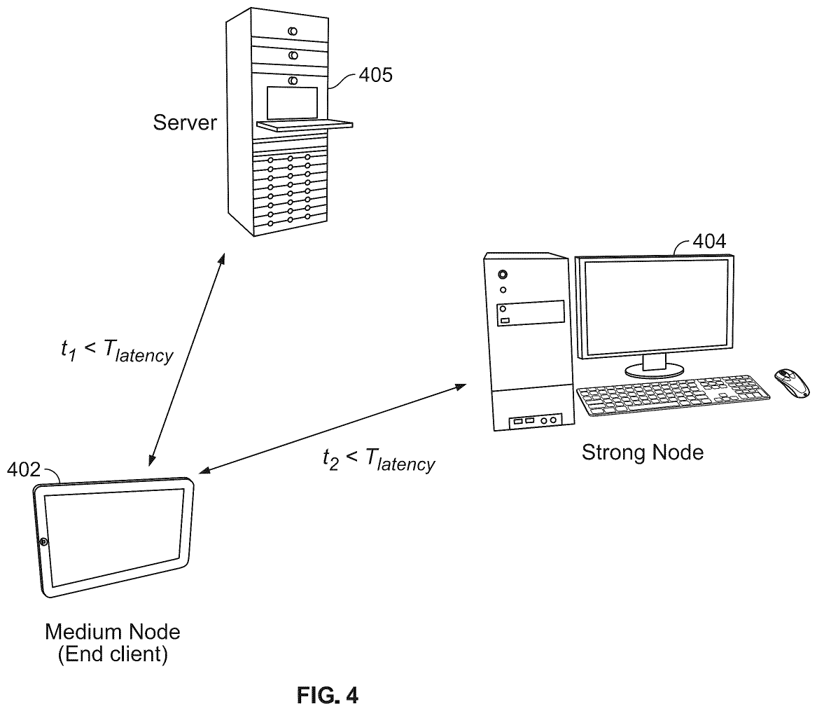

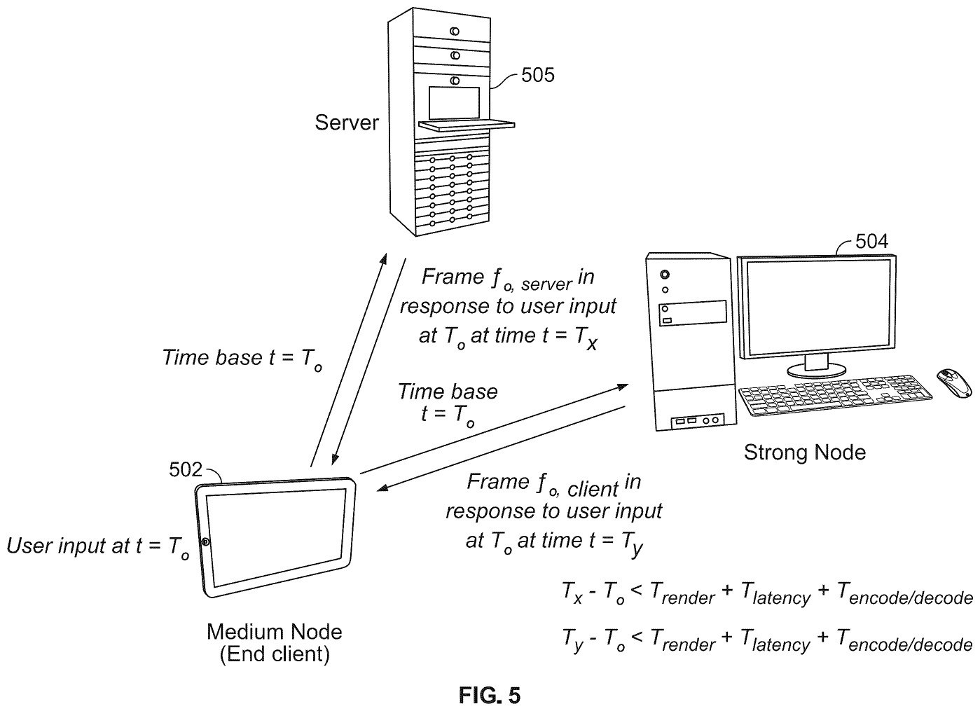

In one embodiment, the hybrid system 100, e.g., via server 105, directs a mid-performance device (e.g., client device 102 of FIG. 1) to perform a latency test, such as, for example, a ping test, for a candidate high-performance device 108, 110 with verified computational power to perform the split rendering tasks assigned. As shown in FIG. 4, medium node (or mid-performance device) 402 pings server 405 and high-performance device (or strong node) 404 to verify that the network component of the latency budget for both server and high-performance device (t₁ and t₂ respectively) are less than an upper bound round-trip time (RTT) latency value T_{latency} for the experience to have acceptable interactivity.

To ensure time synchronization, in some embodiments, such as shown in FIG. 5, the mid-performance device 502, the end client, generates a time base that it sends to server 505 and the client high-performance device 504, as well as any other nodes assigned tasks. The time base may correspond to a value indicative of a reference time at the client device (e.g., a frame number). The time base is, in some embodiments, generated in response to a user input, or it may be generated by the mid-performance device 502 periodically. A time base may represent a start time in some embodiments. When, for example, user input is applied at time t=Tₒ, the hybrid system 100 sends time base Tₒ along with the input to each of the machines 505 and 504 completing tasks. In response to this input, the server 505 may generate a frame of a stream f_{o,server} while the high-performance 504 device may generate frame f_{o,client}. The time base may be embedded in the frame packets to help the mid-performance device 102 identify and composite the correct frames generated corresponding to the same time base. Further, if frame f_{o,server} arrives at time Tx and frame f_{o,client} arrives at Ty, then (Tx−To) and (Ty−To) must each be less than an upper bound of total latency budget which includes upper bounds on time allocated for a rendering, encoding, transmission and decoding:

$${T}_{x} - {T}_{0} < {T}_{rendering} + {T}_{latency} + {T}_{encoding / decoding} .$$

Since the hybrid system 100 performs rendering and encoding/decoding for every frame of a stream, the upper bound on sum of the render time and encode/decode time is the reciprocal of the frame rate:

$${T}_{x} - {T}_{o} < {T}_{latency} + \frac{1}{frame rate}$$

Each of the high-performance devices, server 505 and high-performance device 504, may be configured to separately meet this upper bound constraint. Note, T_{latency} is typically a property of the application, and if it is verified by the mid-performance device 502 that the ping to each high-performance device 504 is less than this value, then the above equation will also hold true, provided the rendering machine has sufficient computing power.

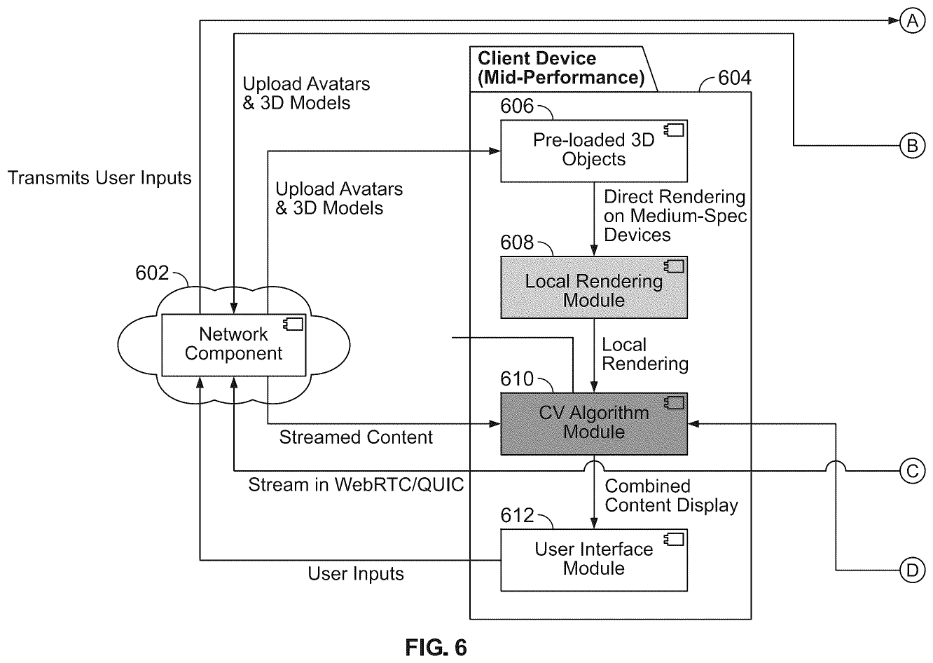

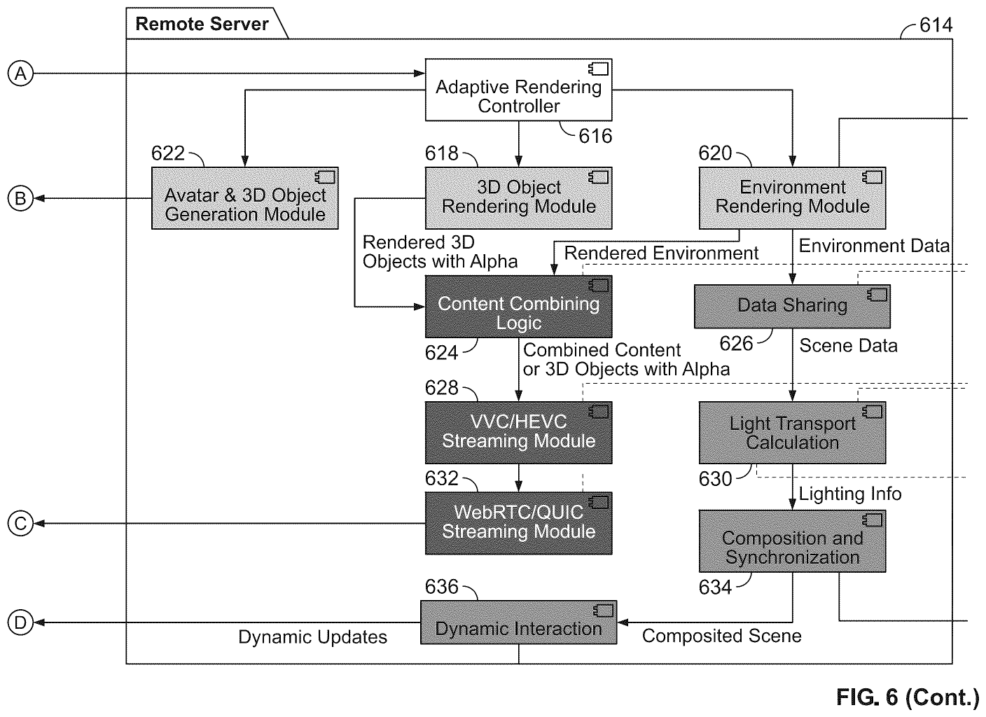

FIG. 6 depicts an example architecture of the hybrid system 100, in accordance with some embodiments of this disclosure, e.g., integrating a mid-performance device 604 and high-performance server 614. In such embodiments, the mid-performance device 604 includes a user interface module 612, which manages user interactions, processes inputs for gaming or 3D modeling activities, and displays the resulting content. It acts as the primary interface for users to engage with the application. The mid-performance device 604 may also include a local rendering module 608, which renders dynamic objects frequently encountered within a 3D environment of an application, such as players' avatars. This local processing ensures minimal latency and maximum responsiveness, which are crucial for interactive applications. The mid-performance device 604 may also include a CV algorithm module 610, which integrates streamed content from the server 614 with locally rendered elements. The CV algorithm module 610 uses CV algorithms to seamlessly merge environments and objects within an application, maintaining visual consistency and immersion. In some embodiments, the mid-performance device 604 also includes preloaded 3D objects module 606.

In the embodiment depicted in FIG. 6, the server 614 also includes multiple components. In some embodiments, the server 614 includes an environment rendering module 620 and 3D object rendering module 618 to generate detailed visuals of the 3D environment and specific 3D objects. These modules process complex scenes and objects that require significant computational resources to offload the computational burden from mid-performance device or devices 604. In some embodiments, the server 614 further includes an adaptive rendering controller 616, which receives user inputs via a network component 602 and intelligently directs the rendering tasks between the environment rendering module 620 and the 3D object rendering module 618. The adaptive rendering controller 616 dynamically adjusts rendering strategies based on user activity and system demands. In some embodiments, the server further includes a VVC/HEVC encoding module 628, which prepares the rendered content for transmission, utilizing advanced video coding technologies (VVC or HEVC) to efficiently encode high-quality visuals, including those with alpha channels for transparency effects. In some embodiments, the server 614 further includes a WebRTC/QUIC streaming module 632, which handles the streaming of encoded visuals over WebRTC/QUIC technology. This module enables real-time, low latency video streaming directly to client devices, facilitating seamless interactive experiences in gaming and 3D projects. In some embodiments, the server further includes content combining logic module 624, which integrates the output from the environment rendering module 620 and the 3D object rendering module 618. Based on the context, it decides whether to combine these elements into a single stream or prioritize specific content.

In some embodiments, the server 614 includes additional components such as an avatar and 3D object generation module 622, which generates avatars and 3D models for client devices to download and render locally, enhancing the customization and dynamic nature of the gaming or 3D collaborative experience. In some embodiments, the server further includes a data sharing module 626 which ensures that all environmental data, including textures and global lighting information, is shared effectively, a light transport calculation module 630 to calculate and apply lighting dynamics, a compositing and synchronization module 634 to integrate and synchronize rendered content, and a dynamic interaction module 636 to manage real-time interactions and updates. These components maintain the fidelity and dynamics of the virtual scene.

The integrated system 100 also includes a network component 602, which acts as the communication backbone of the system, facilitating the transfer of user inputs from the mid-performance device 604, in some embodiments, a client device, to the adaptive rendering controller 616 and streaming the processed visual content back to the mid-performance device 604. This approach ensures efficient use of bandwidth and minimizes transmission delays.

An example workflow of the embodiments is also shown in FIG. 6. The workflow begins with a detected interaction. For example, the hybrid system 100 may detect input indicating that a user has made a selection. The user interface module 612 captures inputs, and the hybrid system sends the input to the server 614 via the network component 602, which further communicates with the adaptive rendering controller 616. The adaptive rendering controller 616 then allocates a set of rendering tasks for responding to the received input among the environment and 3D objects based on information about the tasks and the available devices. For example, in FIG. 6, the adaptive rendering controller 616 divides tasks between the avatar and 3D object generation module 622 and the environment rendering module 620. In some embodiments, the avatar and 3D object generation module 622 generates avatars and 3D objects, the 3D object rendering module 618 controls rendering, and the environment rendering module 620 controls environment rendering. The avatar and 3D object generation module 622 may also create the necessary 3D objects or avatars for client devices to download, which may be tailored to a session's specific requirements and informed by data from the mid-performance device 604, including CPU/GPU load, battery life, and bandwidth status. The adaptive rendering controller 616 may also dynamically adapt to inputs and preferences.

The server 614 then performs the selected rendering tasks. Once completed, the visual results of the tasks may be encoded with VVC/HEVC codecs and streamed using WebRTC/QUIC technology, ensuring high-quality video with efficient bandwidth use. In the embodiment of FIG. 6, the avatar and 3D object generation module 622 sends output to the network 60,2 which further sends this data to the CV algorithm module of 610 the mid-performance device 604. The 3D object rendering module 618 and environment rendering module 620 may transmit rendered 3D objects with alpha and rendered environment data, respectively, to the content combining logic module 624, which further transmits data to the VVC/HEVC streaming module 628. The VVC/HEVC streaming module may then transmit data to a WebRTC/QUIC streaming module 632 to be sent to the network 602. The content combining logic module 624 ensures that the streamed content is appropriately prepared, either as a combined stream or focusing on specific elements like 3D objects with transparency. At the same time, in some embodiments, the mid-performance devices 604 perform the selected rendering tasks assigned to those machines.

In the embodiment of FIG. 6, the environment rendering module 620 also sends environment data to the data sharing module 626, which transmits data to the light transport calculation module 630. The light transport calculation module 630 transmits data to the composition and synchronization module 634, which sends data to the dynamic interaction module 636 to be sent to the CV algorithm module 610 of the mid-performance device 604.

In the workflow of the embodiment of FIG. 6, mid-performance devices 604 also download avatars and 3D models from the network component 602. The local rendering module 608 of the mid-performance device 604 may direct rendering of these objects, and send the rendering (rendered content) to the CV algorithm module 610, which merges the streamed content with locally rendered elements. The CV algorithm module 610 may further transmit combined content for display on the user interface module 612. This process maintains visual fidelity and provides users a seamless and immersive experience. Finally, detected interactions continuously inform the adaptive rendering controller 616, allowing the system to respond dynamically to changing conditions and user demands, as part of a feedback loop.

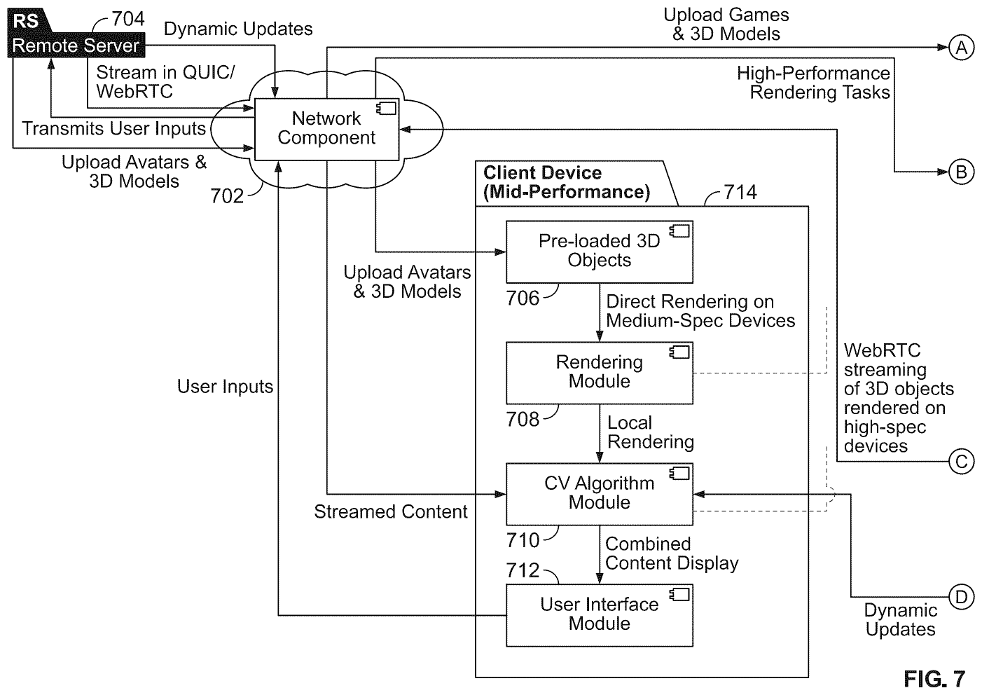

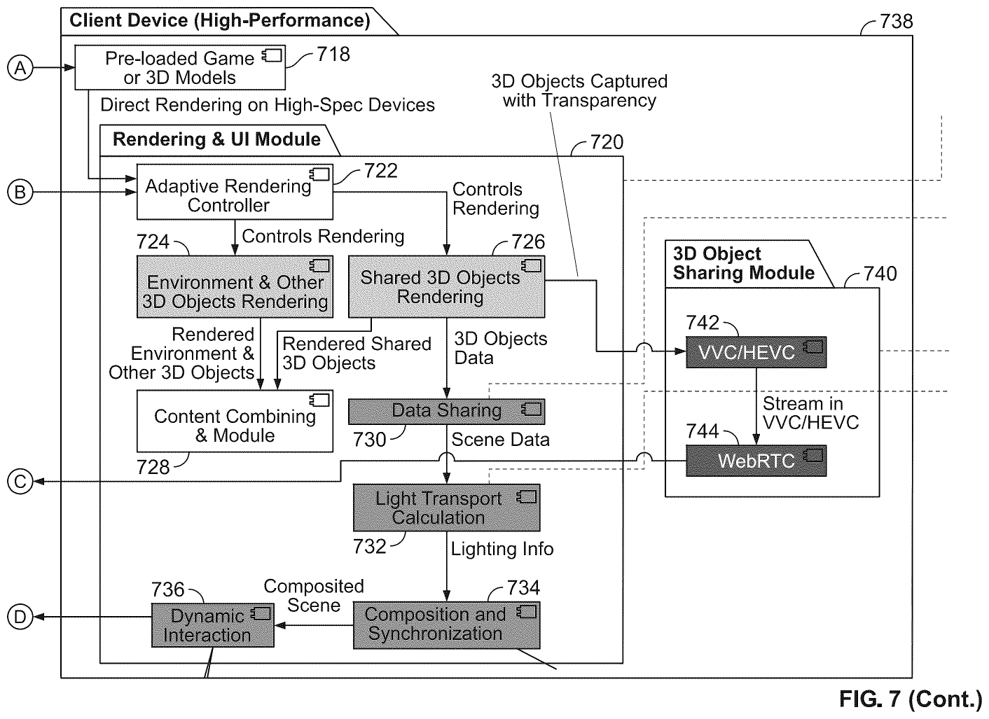

An example embodiment is shown in FIG. 7, in which the hybrid system 100 extends through mid-performance devices 714, high-performance devices 738, and a high-performance remote server 704. The high-performance devices 738 may be a device(s) such as an XR headset or a gaming computer. It may store high-definition games and 3D models ready for immediate rendering as preloaded games or 3D models, making the most of the device's superior processing capabilities.

The high-performance device 738 may also include a rendering and user interface module 720. The rendering and user interface module 720 may also include an adaptive rendering controller 722, which adjusts rendering tasks dynamically and/or in real-time based on user input, optimizing the rendering process for efficiency and visual quality; environment and other 3D objects rendering module 724 to process complex rendering tasks, including environmental details and various 3D objects; shared 3D objects rendering module 726 to specifically render 3D objects intended for sharing across devices, ensuring they are prepared transparently for collaborative interactions, and a content combining and user interface module 728, which merges different rendered content pieces for the final display, maintaining the consistency and coherence of visual experience. The rendering and user interface module 720 may further include data sharing to transmit detailed object and environmental data to mid-performance devices, including textures and lighting information; light transport calculation to manage all lighting calculations for the environment and shared objects; composition and synchronization to ensure that all rendered elements are accurately composited and synchronized for consistent presentation; and dynamic interaction to handle real-time adjustments to the rendered content based on user interactions and environmental changes.

The high-performance device 738 may also include a 3D objects sharing module 740 which further includes a versatile video coding/high-efficiency video coding (VVC/HEVC) module 742 and a WebRTC/QUIC module 744 that enables the efficient streaming of rendered 3D objects with transparency details over the internet, facilitating real-time collaboration and interaction.

The embodiment shown in FIG. 7 further includes a high-performance remote server 704. This high-performance remote server 704 acts as a repository and streaming hub for high-quality 3D models and environments not handled locally by client devices, mid-performance device 714 and high-performance device 738, like the embodiment shown in FIG. 6.

The processes of some embodiments including a mid-performance device 714, high-performance device 738, and high-performance remote server 704 may follow a similar workflow as the embodiment shown in FIG. 6. However, some elements of the processes previously managed by the server may, in these embodiments, be managed by the high-performance device 738. For example, in the embodiment shown in FIG. 7, the adaptive rendering controller 722 is located within the high-performance device 738 rather than the high-performance remote server 704. As a result, the workflow of FIG. 7 reflects this change.

In the embodiment shown in FIG. 7, the workflow may begin with input detected at the mid-performance device 714. The remote high-performance server 704 may receive this user input from the network 702 and return to the network 702 avatars and other 3D models, streams in WebRTC/QUIC, and dynamic updates, in response to the received input.

The high-performance device 738, in the embodiment shown in FIG. 7, on the other hand, receives from the network 702, preloaded 3D models and transfers them to a rendering and UI module 720. The rendering and UI module 720 may include an adaptive rendering controller 722, which receives high-performance rendering tasks from the network 702. The adaptive rendering controller 722, in some embodiments, then divides tasks between an environment and other 3D objects rendering module 724 and a shared 3D objects rendering module 726, which may both forward data to a content combining and UI module 728. The environment and other 3D objects rendering module 724 may also send environment data to the data sharing module 730, which transmits data to the light transport calculation module 732. The light transport calculation module 732 in some embodiments transmits data to the compositing and synchronization module 734, which sends data to the dynamic interaction module 736. In some embodiments, the shared 3D objects rendering module 726 forwards data to a 3D object sharing module 740, processing information through a VVC/HEVC module 742 then streams to a WebRTC element 744.

Such processes allow high-performance devices 738 to leverage their advanced capabilities to render detailed 3D models including games and other objects designed for collaborative work. Elements of the models may be streamed to mid-performance devices 714 through efficient video streaming technologies, supporting interactive and collaborative engagements in real time.

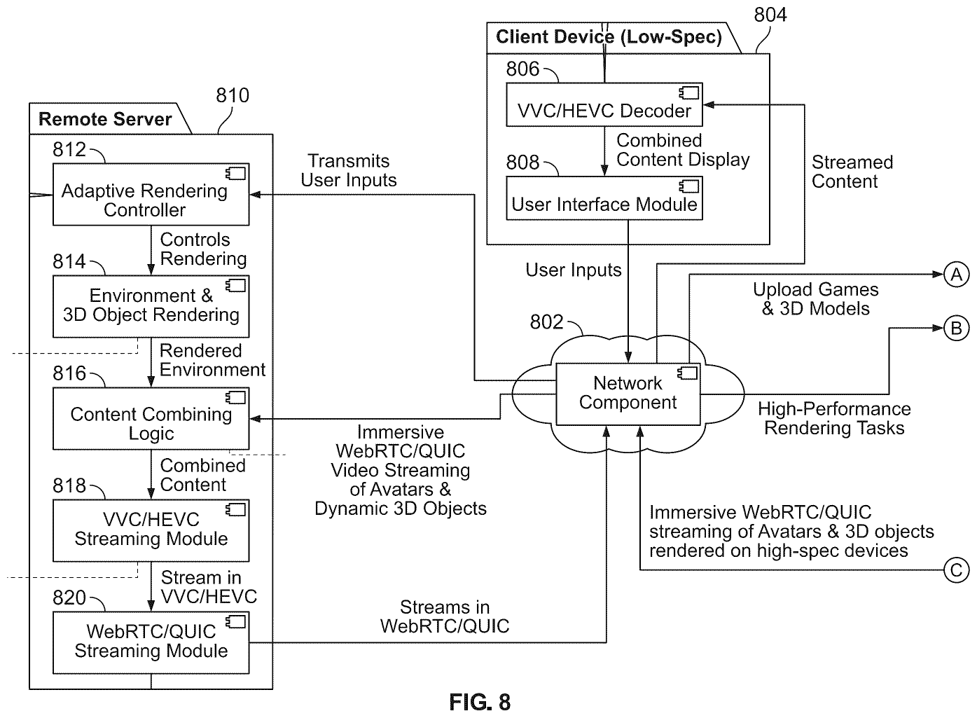

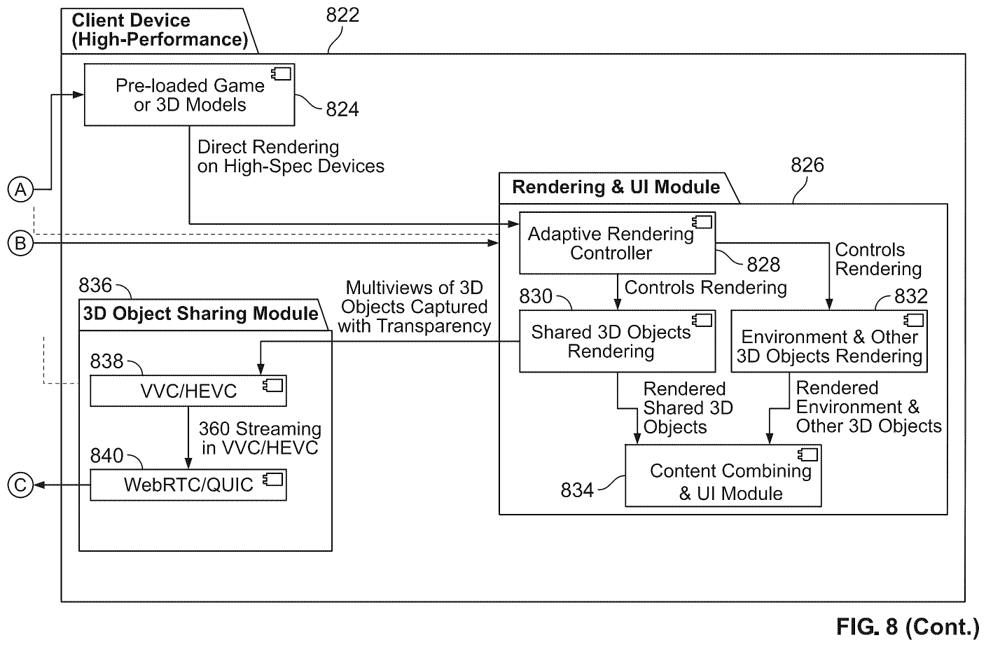

In the embodiment shown in FIG. 8, the hybrid system 100 enables immersive gaming and collaborative work on 3D models across devices with low performance and high-performance, as well as through a remote server 810. The hybrid system 100 utilizes advanced video codecs and streaming technologies to ensure all devices' seamless and interactive experience.

In addition to elements present in the previously described embodiments, the embodiments such as shown in FIG. 8 also include low-performance devices 804. These devices may include a user interface module 808 to capture user interactions and manage the application's display on the low-performance devices 804, ensuring that the devices can smoothly navigate and interact with the content. The low-performance devices 804 may also include a VVC/HEVC Decoder 806 which decodes streamed content in VVC/HEVC formats, allowing for the efficient display of high-quality video on devices with limited processing power.

The processes of some embodiments including a low-performance devices 804, high-performance devices, 822 and a remote server 810 follow a similar workflow as the embodiments shown in FIGS. 6 and 7. In these embodiments, the integration includes a low-performance device 804 which includes a VVC/HEVC decoder 806 and a user interface module 808. The VVC/HEVC decoder 806 may receive information from the network 802 and transmit information to the user interface module 808, which may further transmit input and other data back to the network 802. The network 802 may then transmit data incorporating information from the low-performance device 804 to the remote server 810 or high-performance device 822. The remote server 810 and high-performance device 822 may use this information, as well as other information available in the hybrid system 100, as in other embodiments. To process processor heavy tasks and combine elements to ensure that all users receive a coherent and integrated view of the game or project environment.

For example, the high-performance device 822 shown in FIG. 8 functions, like that of the embodiment of FIG. 7, receives from the network 802 or cloud servers, preloaded 3D models and transfers them to a rendering and UI module 826. The rendering and UI module 826 may include an adaptive rendering controller 828, which receives high-performance rendering tasks, such as rendering detailed environments and 3D models, from the network 802. The adaptive rendering controller 828 in some embodiments then intelligently divides tasks between an environment and other 3D objects rendering element 832 and a shared 3D objects rendering element 830, which may both forward data to a content combining and module 834. In some embodiments, the adaptive rendering controller 828 creates objects tailored to a session's specific requirements and informed by data from the various devices 804 and 822, including CPU/GPU load, battery life, and bandwidth status. It may dynamically adapt to activities and preferences as well. In some embodiments, the shared 3D objects rendering element 830 forwards data to a 3D object sharing module 836, processing information through a VVC/HEVC element 838 then streaming to a WebRTC element 840.

The remote server 810 of FIG. 8 may also include an adaptive rendering controller 812, which receives input, such as from low-performance device 804, and other data from network 802. The adaptive rendering controller 812 of server 810 may also control rendering modules, such as the remote server's 810 environment and 3D object rendering module 814, which may render the background environment of an application. Remote server 810 may also include a content combining logic module 816, which in some embodiments receives data from network 802 and environment and 3D object rendering module 814, and may combine different elements and process the information to a VVC/HEVC encoding module 818 to stream to a WebRTC/QUIC streaming module 820. In some embodiments, hybrid system 100 streams combined content directly from remote servers 810 to low-performance devices 804.

In some embodiments, content necessary for rendering, such as games and 3D models, is preloaded from cloud servers onto high-performance devices. Meanwhile, combined content is streamed directly from servers to low-spec devices. High-performance devices contribute to the content pool by sharing complex 3D objects. In contrast, low-spec devices decode and display the streamed content, allowing users with limited hardware to engage fully in the experience. Users interact with the application through intuitive interfaces, with their inputs influencing the adaptive rendering process. The system ensures that all participants, regardless of their device's specifications, can enjoy a rich, interactive, and immersive experience, fostering collaboration and enjoyment in high-quality AAA games or 3D projects. By leveraging server resources and the computational power of high-performance client devices, the system facilitates an inclusive environment where users on a broad spectrum of hardware can participate in demanding gaming and collaborative 3D modeling projects. This balanced distribution of rendering tasks ensures efficient resource use and delivers all users a high-quality, immersive experience.

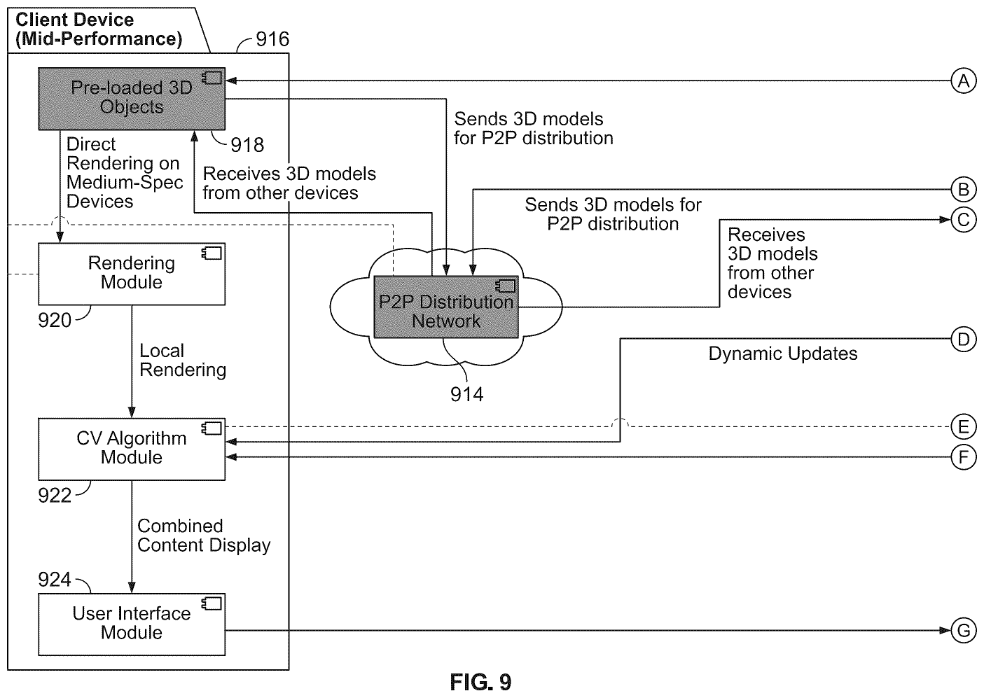

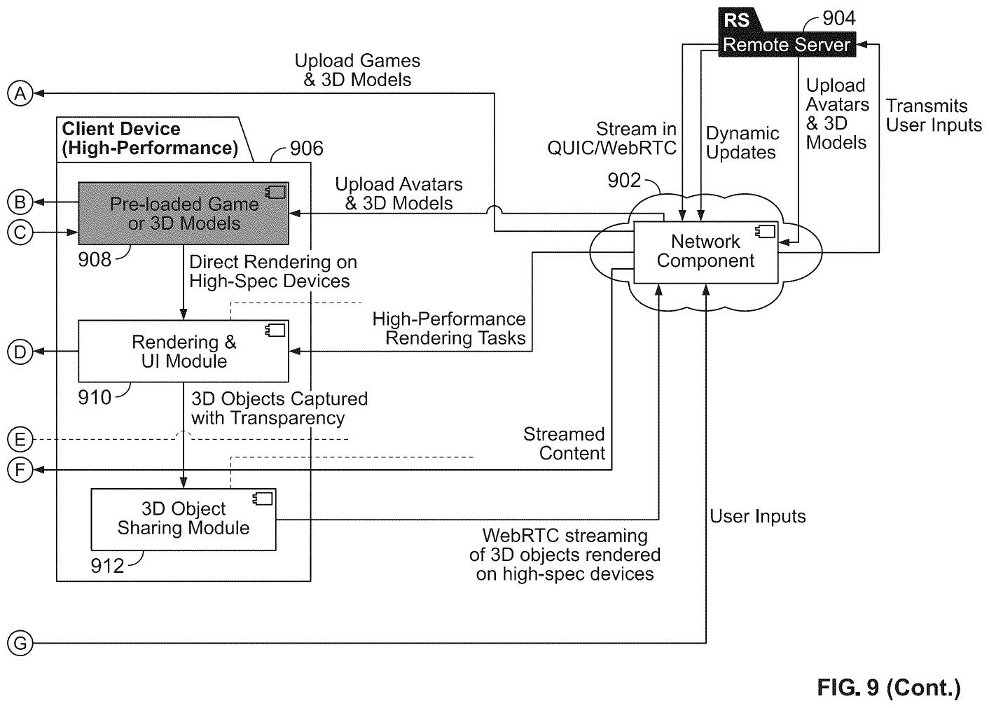

In the embodiment shown in FIG. 9, the hybrid system 100 enables immersive gaming and collaborative work on 3D models across high-performance and mid-performance client devices 906 and 916, a remote server 904, and a peer-to-peer (P2P) distribution network 914. This setup enhances interactivity and performance in gaming and 3D modeling environments by effectively distributing computational and rendering tasks according to device capabilities. The P2P distribution network 914 provides a robust mechanism for exchanging 3D models directly between devices 906 and 916. This connection decreases reliance on the server for continuous data streaming and supports real-time updates and interactions by minimizing delays typically associated with centralized data distribution.

The mid-performance device 916 of the embodiment shown in FIG. 9 may include, for example, preloaded 3D objects module 918, which may communicate with the P2P distribution network 914 and/or network 902 to receive 3D models from other devices as well as send 3D models to other devices. The preloaded 3D objects module 918 may also feed into a rendering module 920 on the mid-performance device 916. In some embodiments, preloaded 3D objects module 918 may comprise relatively less resource-intensive 3D models suitable for devices with moderate processing power. The rendering module 920 in some embodiments renders, for example, player avatars and dynamic objects locally and combines rendered data in the CV algorithm module 922 to be transmitted to a user interface module for display and interaction. The CV algorithm module 922 may also receive data from the rendering and UI module 910 of high-performance device 906 as well as the network 902. The user interface module 924 may further send data to a network 902 connecting the other devices 906 in the embodiment and the server 904.

Similarly, the high-performance device 906 also receives 3D models from the P2P distribution network 914 and/or network 902 to a preloaded game or 3D models module 908. The preloaded game or 3D models module 908 may also send 3D models to the P2P distribution network 914. The high-performance device 906 may direct rendering to the rendering and UI module 910 of the device, which may render objects and transfer the renderings to a 3D object sharing module 912 to be forwarded to the network 902 to be shared throughout the system 100.

The remote server 904 may receive input from the network 902 and return avatars and 3D models, dynamic updates, and streams in WebRTC/QUIC/for use in the system 100.

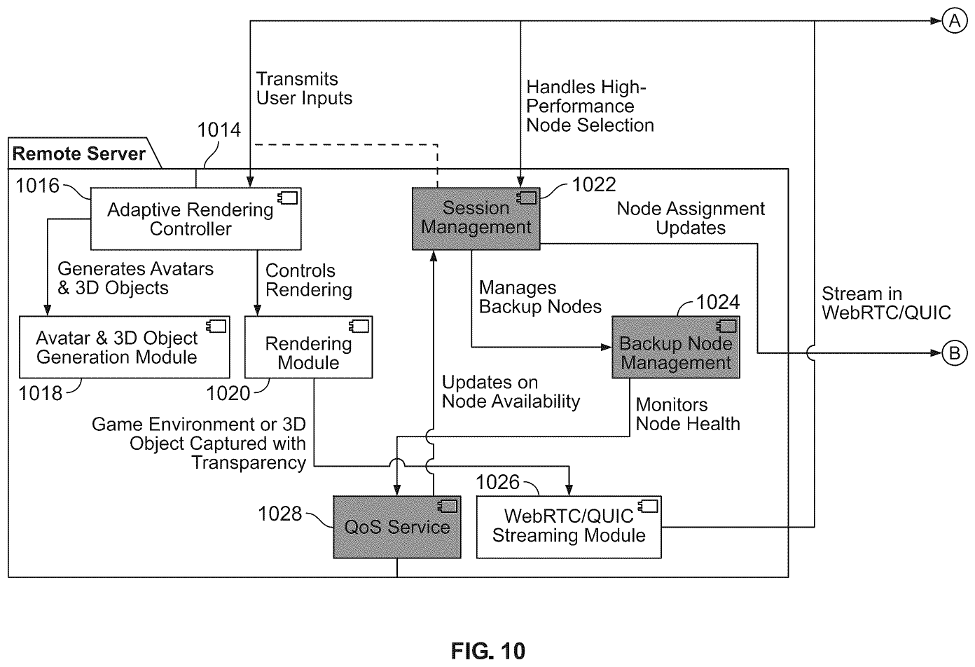

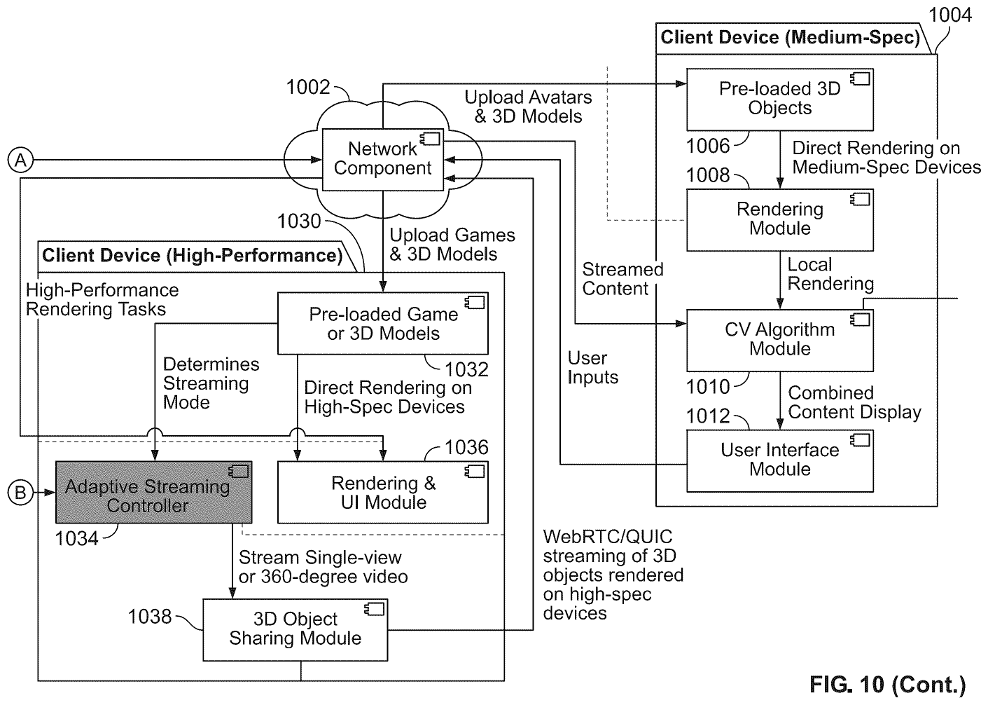

In the embodiment shown in FIG. 10, the hybrid system 100 connects a remote server 1014, and high-performance device 1030, and a mid-performance device 1004. The mid-performance device 1004 of the embodiment shown in FIG. 10 may include, for example, preloaded 3D objects module 1006, which may communicate with the network component 1002 to receive 3D models from other devices. The preloaded 3D objects module 1006, may also feed into a rendering module 1008 on the mid-performance device 1004. The rendering module 1008 in some embodiments renders objects locally and combines rendered data in the CV algorithm module 1010 to be transmitted to a user interface module 1012 for display and interaction. The CV algorithm module 1010 may also receive data from the network component 1002. The user interface module 1012 may further send data to a network component 1002 connecting the other devices, such as, for example, high-performance device 1030, and the remote server 1014.

The high-performance device 1030 may receive from the network component 1002 games, 3D models, or other advanced application assets and stores them in the preloaded game or 3D model module 1032. It then may forward data for direct rendering to the rendering and UI module 1036, which handles demanding processing tasks. In some embodiments, it may send data to an adaptive streaming controller 1034 to determine the most efficient streaming mode. The adaptive streaming controller 1034 assesses device capacity and the number of viewers to choose between direct single-view streaming to individual clients or more resource-efficient video streaming when viewer demand exceeds device capabilities. The adaptive streaming controller 1034 may send the determination to a 3D object sharing module 1038. The 3D object sharing module 1038 captures detailed 3D objects with transparency and is responsible for streaming them, based on the streaming mode determined by the adaptive streaming controller 1034.

The server 1014 may also receive input from the network component 1002 to its adaptive rendering controller 1016 and in response generate 3D objects by way of an avatar and 3D object generation module 1018. The adaptive rendering controller 1016 may also forward data to a rendering module 1020 to control rendering of 3D objects or environments. Once these renderings are complete, the rendering module 1020 may send the rendering to a WebRTC/QUIC streaming module 1026 to be streamed to devices. In some embodiments, network component 1002 acts as the conduit through which all user inputs, streamed content, and system commands flow, to facilitate communication between the remote server and client devices.

At the same time, the remote server 1014 may receive data regarding available devices to a session management module 1022, which selects high-performance devices such as high-performance device 1030. The session management module 1022 may then communicate with adaptive streaming controller 1034 to send assignments and updates. It may also select back up devices via the backup node management module 1024. The backup node management module 1024 may monitor device health and feed this data to a QoS service module 1028, which evaluates and maintains session quality and device performance, and informs the session management module 1022, which may use this data for task assignment.

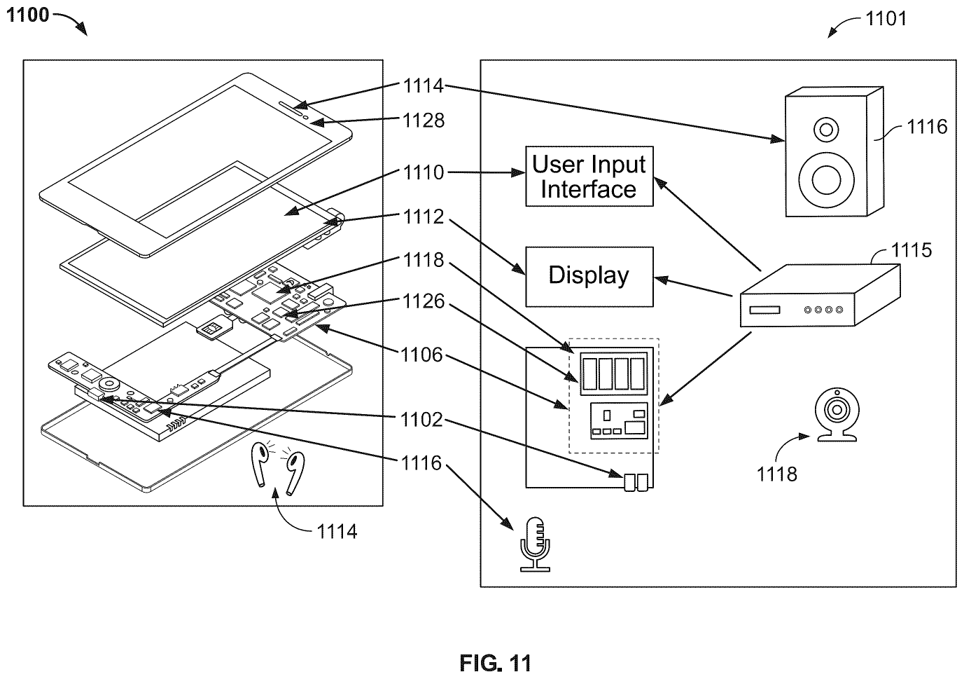

FIGS. 11-12 show illustrative devices, systems, servers, and related hardware for selecting a node to be assigned a processing task, in accordance with some embodiments of this disclosure. FIG. 11 shows generalized embodiments of illustrative computing devices 1100 and 1101, which may correspond to, e.g., a smart phone; a tablet; a laptop computer; a personal computer; a desktop computer; a smart television; a smart watch or wearable device; smart glasses; a stereoscopic display; a wearable camera; virtual reality (VR) glasses; VR goggles; a stereoscopic display; augmented reality (AR) glasses; an AR head-mounted display (HMD); a VR HMD; or any other suitable computing device; or any combination thereof. In another example, computing device 1101 may be a user television equipment system or device. In some embodiments, computing devices 1100 and 1101 may correspond to, e.g., one or more of client device 102 or 110.

User television equipment device 1101 may include set-top box 1115. Set-top box 1115 may be communicatively connected to microphone 1116, Audio output equipment (e.g., speaker or headphones 1114), and display 1112. In some embodiments, microphone 1116 may receive audio corresponding to a voice of a user providing input. In some embodiments, display 1112 may be a television display or a computer display. In some embodiments, set-top box 1115 may be communicatively connected to user input interface 1110. In some embodiments, user input interface 1110 may be a remote control device. Set-top box 1115 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of computing devices are discussed below in connection with FIG. 12. In some embodiments, computing device 1100 may comprise any suitable number of sensors (e.g., gyroscope or gyrometer, or accelerometer, etc.), and/or a GPS module (e.g., in communication with one or more servers and/or cell towers and/or satellites) to ascertain a location of computing device 1100. In some embodiments, computing device 1100 comprises a rechargeable battery that is configured to provide power to the components of the device.

Each one of computing device 1100 and computing device 1101 may receive content and data via input/output (I/O) path 1102. I/O path 1102 may provide content (e.g., broadcast programming, on-demand programming, Internet content, content available over a local area network (LAN) or wide area network (WAN), and/or other content) and data to control circuitry 1104, which may comprise processing circuitry 1106 and storage 1108. Control circuitry 1104 may be used to send and receive commands, requests, and other suitable data using I/O path 1102, which may comprise I/O circuitry. I/O path 1102 may connect control circuitry 1104 (and specifically processing circuitry 1106) to one or more communications paths (described below). I/O functions may be provided by one or more of these communications paths, but are shown as a single path in FIG. 11 to avoid overcomplicating the drawing. While set-top box 1115 is shown in FIG. 11 for illustration, any suitable computing device having processing circuitry, control circuitry, and storage may be used in accordance with the present disclosure. For example, set-top box 1115 may be replaced by, or complemented by, a personal computer (e.g., a notebook, a laptop, a desktop), a smartphone (e.g., computing device 1100), an XR device; a tablet; a network-based server hosting a user-accessible client device; a non-user-owned device; any other suitable device; or any combination thereof.

Control circuitry 1104 may be based on any suitable control circuitry such as processing circuitry 1106. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1104 executes instructions for the hybrid system stored in memory (e.g., storage 1108). Specifically, control circuitry 1104 may be instructed by the hybrid system to perform the functions discussed above and below. In some implementations, processing or actions performed by control circuitry 1104 may be based on instructions received from the hybrid system.

In client/server-based embodiments, control circuitry 1104 may include communications circuitry suitable for communicating with a server or other networks or servers. The hybrid system may be a stand-alone application implemented on a device or a server. The hybrid system may be implemented as software or a set of executable instructions. The instructions for performing any of the embodiments discussed herein of the hybrid system may be encoded on non-transitory computer-readable media (e.g., a hard drive, random-access memory on a DRAM integrated circuit, read-only memory on a BLU-RAY disk, etc.). For example, in FIG. 1, the instructions may be stored in storage 1108, and executed by control circuitry 1104 of a device 1100.

In some embodiments, the hybrid system may be a client/server application where only the client application resides on device 1100 (e.g., device 1104), and a server application resides on an external server (e.g., server 1204). For example, the hybrid system may be implemented partially as a client application on control circuitry 1104 of device 1100 and partially on server 1204 as a server application running on control circuitry 1213. Server 1204 may be a part of a local area network with one or more of devices 1100, 1101 or may be part of a cloud computing environment accessed via the Internet. In a cloud computing environment, various types of computing services for performing searches on the Internet or informational databases, providing video communication capabilities, providing storage (e.g., for a database) or parsing data are provided by a collection of network-accessible computing and storage resources (e.g., server 904 and/or an edge computing device), referred to as “the cloud.” Device 1100 may be a cloud client that relies on the cloud computing capabilities from server 904 to determine whether processing (e.g., at least a portion of virtual background processing and/or at least a portion of other processing tasks) should be offloaded from the mobile device, and facilitate such offloading. When executed by control circuitry of server 904, the hybrid system may instruct control circuitry 911 to perform processing tasks for the client device and facilitate the generation of encoding data. The client application may instruct control circuitry 1104 to determine whether processing should be offloaded.

Control circuitry 1104 may include communications circuitry suitable for communicating with a server, edge computing systems and devices, a table or database server, or other networks or servers The instructions for carrying out the above mentioned functionality may be stored on a server (which is described in more detail in connection with FIG. 9. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 9). In addition, communications circuitry may include circuitry that enables peer-to-peer communication of computing devices, or communication of computing devices in locations remote from each other (described in more detail below).

Memory may be an electronic storage device provided as storage 1108 that is part of control circuitry 1104. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1108 may be used to store various types of content described herein as well as the hybrid system data described above. Nonvolatile memory may also be used (e.g., to launch a boot-up routine and other instructions). Cloud-based storage, described in more detail in relation to FIG. 12, may be used to supplement storage 1108 or instead of storage 1108.

Control circuitry 1104 may include video generating circuitry and tuning circuitry, such as one or more analog tuners, or HEVC decoders or any other suitable digital decoding circuitry, high-definition tuners, or any other suitable tuning or video circuits or combinations of such circuits. Encoding circuitry (e.g., for converting over-the-air, analog, or digital signals to SHVC or any other suitable signals for storage) may also be provided. Control circuitry 1104 may also include scaler circuitry for upconverting and downconverting content into the preferred output format of computing device 1100. Control circuitry 1104 may also include digital-to-analog converter circuitry and analog-to-digital converter circuitry for converting between digital and analog signals. The tuning and encoding circuitry may be used by computing device 1100, 1101 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 1108 is provided as a separate device from computing device 1100, the tuning and encoding circuitry (including multiple tuners) may be associated with storage 1108.

Control circuitry 1104 may receive instruction from a user by way of user input interface 1110. User input interface 1110 may be any suitable user interface, such as a remote control, mouse, trackball, keypad, keyboard, touch screen, touchpad, stylus input, joystick, voice recognition interface, or other user input interfaces. Display 1112 may be provided as a stand-alone device or integrated with other elements of each one of computing device 1100 and computing device 1101. For example, display 1112 may be a touchscreen or touch-sensitive display. In such circumstances, user input interface 1110 may be integrated with or combined with display 1112. In some embodiments, user input interface 1110 includes a remote-control device having one or more microphones, buttons, keypads, any other components configured to receive user input or combinations thereof. For example, user input interface 1110 may include a handheld remote-control device having an alphanumeric keypad and option buttons. In a further example, user input interface 1110 may include a handheld remote-control device having a microphone and control circuitry configured to receive and identify voice commands and transmit information to set-top box 1115.

Audio output equipment 1114 may be integrated with or combined with display 1112. Display 1112 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 1112. Audio output equipment 1114 may be provided as integrated with other elements of each one of computing device 1100 and computing device 1101 or may be stand-alone units. An audio component of videos and other content displayed on display 1112 may be played through speakers (or headphones) of audio output equipment 1114. In some embodiments, audio may be distributed to a receiver (not shown), which processes and outputs the audio via speakers of audio output equipment 1114. In some embodiments, for example, control circuitry 1104 is configured to provide audio cues to a user, or other audio feedback to a user, using speakers of audio output equipment 1114. There may be a separate microphone 1116 or audio output equipment 1114 may include a microphone configured to receive audio input such as voice commands or speech. For example, a user may speak letters or words or terms or numbers that are received by the microphone and converted to text by control circuitry 1104. In a further example, a user may voice commands that are received by a microphone and recognized by control circuitry 1104. Camera 1118 may be any suitable video camera integrated with the equipment or externally connected. Camera 1118 may be a digital camera comprising a charge-coupled device (CCD) and/or a complementary metal-oxide semiconductor (CMOS) image sensor. Camera 1118 may be an analog camera that converts to digital images via a video card.

The hybrid system may be implemented using any suitable architecture. For example, it may be a stand-alone application wholly-implemented on each one of computing device 1100 and computing device 1101. In such an approach, instructions of the application may be stored locally (e.g., in storage 1108), and data for use by the application is downloaded on a periodic basis (e.g., from an out-of-band feed, from an Internet resource, or using another suitable approach). Control circuitry 1104 may retrieve instructions of the application from storage 1108 and process the instructions to provide video conferencing functionality and generate any of the displays discussed herein. Based on the processed instructions, control circuitry 1104 may determine what action to perform when input is received from user input interface 1110. For example, movement of a cursor on a display up/down may be indicated by the processed instructions when user input interface 1110 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 1104 may allow a user to provide user profile information or may automatically compile user profile information. For example, control circuitry 1104 may access and monitor network data, video data, audio data, processing data, participation data from a conference participant profile. Control circuitry 1104 may obtain all or part of other user profiles that are related to a particular user (e.g., via social media networks), and/or obtain information about the user from other sources that control circuitry 1104 may access. As a result, a user can be provided with a unified experience across the user's different devices.

In some embodiments, the hybrid system is or comprises a client/server-based application. Data for use by a thick or thin client implemented on each one of computing device 1100 and computing device 1101 may be retrieved on-demand by issuing requests to a server remote to each one of computing device 1100 and computing device 1101. For example, the remote server may store the instructions for the application in a storage device. The remote server may process the stored instructions using circuitry (e.g., control circuitry 1104) and generate the displays discussed above and below. The client device may receive the displays generated by the remote server and may display the content of the displays locally on computing device 1100. This way, the processing of the instructions is performed remotely by the server while the resulting displays (e.g., that may include text, a keyboard, or other visuals) are provided locally on computing device 1100. Computing device 1100 may receive inputs from the user via input interface 1110 and transmit those inputs to the remote server for processing and generating the corresponding displays. For example, computing device 1100 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to computing device 1100 for presentation to the user.

In some embodiments, the hybrid system may be downloaded and interpreted or otherwise run by an interpreter or virtual machine (run by control circuitry 1104). In some embodiments, the hybrid system may be encoded in the ETV Binary Interchange Format (EBIF), received by control circuitry 1104 as part of a suitable feed, and interpreted by a user agent running on control circuitry 1104. For example, the hybrid system may be an EBIF application. In some embodiments, the hybrid system may be defined by a series of JAVA-based files that are received and run by a local virtual machine or other suitable middleware executed by control circuitry 1104. In some of such embodiments (e.g., those employing H.265, SHVC or any other suitable digital media encoding schemes), the hybrid system may be, for example, encoded and transmitted in using an SHVC with the SHVC audio and video packets of a program.

FIG. 12 is a diagram of an illustrative system 1200 for enabling user controlled extended reality, in accordance with some embodiments of this disclosure. Computing devices 1207, 1208, 1210, 1211 (which may correspond to, e.g., computing device 1200 or 1201) may be coupled to communication network 1209. Communication network 1209 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 1209) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 12 to avoid overcomplicating the drawing.

Although communications paths are not drawn between computing devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The computing devices may also communicate with each other directly through an indirect path via communication network 1209.

System 1200 may comprise media content source 1202, one or more servers 1204, and/or one or more edge computing devices. In some embodiments, the hybrid system may be executed at one or more of control circuitry 1213 of server 1204 (and/or control circuitry of computing devices 1207, 1208, 1210, 1211 and/or control circuitry of one or more edge computing devices). In some embodiments, the media content source and/or server 1304 may be configured to host or otherwise facilitate video communication sessions between computing devices 1207, 1208, 1210, 1211 and/or any other suitable computing devices, and/or host or otherwise be in communication (e.g., over network 1209) with one or more social network services.

In some embodiments, server 1204 may include control circuitry 1213 and storage 1214 (e.g., RAM, ROM, Hard Disk, Removable Disk, etc.). Storage 1214 may store one or more databases. Server 1204 may also include an input/output path 1212. I/O path 1212 may provide video conferencing data, device information, or other data, over a local area network (LAN) or wide area network (WAN), and/or other content and data to control circuitry 1213, which may include processing circuitry, and storage 1214. Control circuitry 1213 may be used to send and receive commands, requests, and other suitable data using I/O path 1212, which may comprise I/O circuitry. I/O path 1212 may connect control circuitry 1213 (and specifically control circuitry) to one or more communications paths.

Control circuitry 1213 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1213 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1213 executes instructions for an emulation system application stored in memory (e.g., the storage 1214). Memory may be an electronic storage device provided as storage 1214 that is part of control circuitry 1213.

Media content source 1202 and/or server 1204 may comprise or correspond to, e.g., server 105 and/or server 110 of FIG. 1. In some embodiments, server 1204 may be included in a CDN, which may include origin servers, data centers, central servers, and/or edge servers, and/or any other suitable components. In some embodiments, spherical media content may be, as ingested, encoded in a particular format, e.g., a pre-encoded media asset. Alternatively, in some embodiments, the spherical media content may be, as ingested, not encoded and/or not compressed, and thus encoding may be performed on an uncompressed and/or raw version after ingest. While a single server 1204 and content source 1202 is shown in FIG. 12, it should be appreciated that any suitable number of servers and content servers (and/or edge servers or any other suitable computing device) may be utilized to perform encoding and/or transcoding, and computing tasks may be distributed across such respective groups of servers. As used herein, “transcoding” refers to manipulating digitally compressed and coded data of at least a portion of media asset, in order to convert such data from a first format (or specification) to a second format (or specification).

Computing devices 1207, 1208, 1210, 1211 may comprise one or more decoders, which may comprise any suitable combination of hardware and/or software configured to convert data in a coded form to a form that is usable as video signals and/or audio signals or any other suitable type of data signal, or any combination thereof. The encoder may comprise any suitable combination of hardware and/or software configured to process data to reduce storage space required to store the data and/or bandwidth required to transmit the image data, while minimizing the impact of the encoding on the quality of the video or one or more images. The encoder and/or decoder may utilize any suitable algorithms and/or compression standards and/or codecs. In some embodiments, the encoder and/or decoder may be a virtual machine that may reside on one or more physical servers that may or may not have specialized hardware, and/or a cloud service may determine how many of these virtual machines to use based on established thresholds. In some embodiments, separate audio and video encoders and/or decoders may be employed.

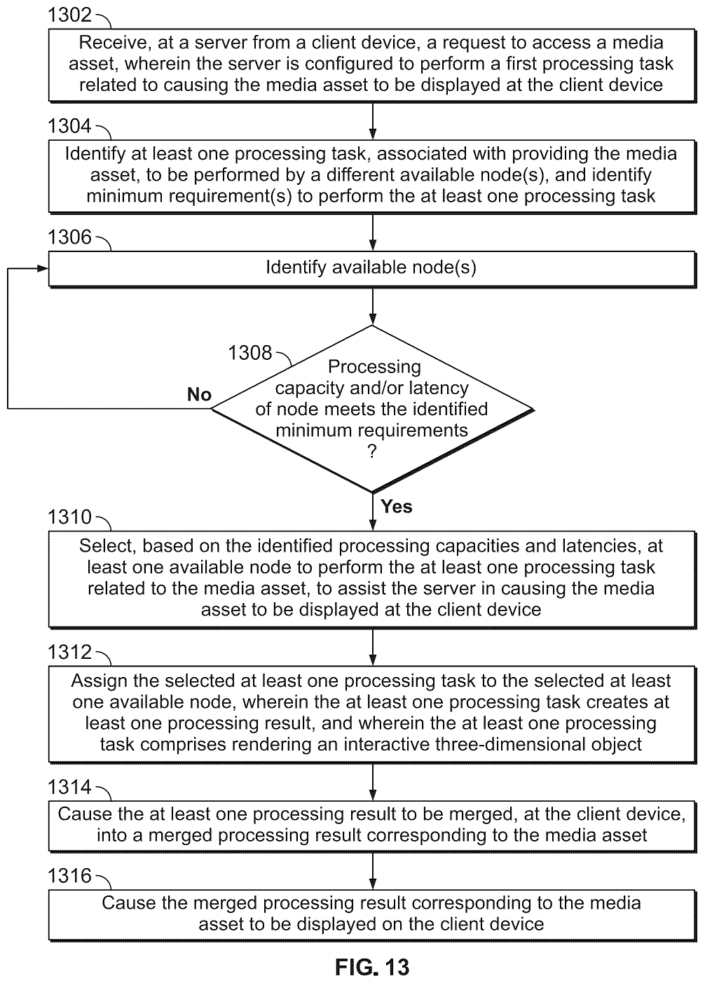

FIG. 13 is an illustrative flowchart of a process for selecting a node to be assigned a processing task, in accordance with some embodiments of this disclosure. In various embodiments, the individual steps of process 1300 may be implemented by one or more components of the devices, methods, and systems of FIGS. 1-12 and may be performed in combination with any of the other processes and aspects described herein. Although the present disclosure may describe certain steps of process 1300 (and of other processes described herein) as being implemented by certain components of the devices, methods, and systems of FIGS. 1-12, this is for purposes of illustration only, and it should be understood that other components of the devices, methods, and systems of FIGS. 1-12 may implement those steps instead.

In process 1300, control circuitry (e.g., control circuitry 1106 of computing device 1100 of FIG. 11 and/or control circuitry 1213 of server 1204 of FIG. 12) may determine to distribute simulation and/or rendering of a media asset to one or more available nodes (e.g., separate devices having respective GPUs), in order to create a composite of all outputs, e.g., to recreate what the user would see if all 3D objects were rendered on same GPU.

At 1302, the control circuitry and/or I/O circuitry (e.g., 1102 of FIGS. 11 and/or 1212 of FIG. 12) may receive (e.g., over a network 103 of FIG. 1) a request to access a media asset. For example, a server (e.g., server 105 of FIG. 1) may receive such request. The request may be a request to access a portion (e.g., a particular object, or a particular frame(s) or scene(s)) of a media asset already being accessed, or to initiate the delivery of the media asset. The media asset may be, for example, a video game, on-demand or live content, XR content, or any other suitable content, or any combination thereof. The server may be configured to perform a first processing task related to causing the media asset to be displayed at the client device (e.g., client device 102 of FIG. 1). For example, the first processing task generating or rendering (e.g., at least in part using a GPU) one or more portions (e.g., one or more 3D objects) of a video game scene 111 of FIG. 1. For example, the server may render object set A, as shown in FIG. 2. In some embodiments, the server may be considered a high-performance node, e.g., having a processing capacity (and/or other parameters) exceeding a threshold, and/or based on the server comprising hardware associated with a higher-performance (e.g., a specialized, high-performance GPU). In some embodiments, server 105 may be, for example, a video game server providing access to at least one portion of a video game.

At 1304, the control circuitry may identify at least one processing task, associated with providing the media asset, to be performed by a different node, and identify minimum requirements to perform the at least one processing task. In some embodiments identifying the at least one processing task includes receiving a list of tasks required to provide the media asset and dividing the tasks into mutually independent sets such that each set of tasks can be rendered directly, including responsive to user input, without impact on rendering tasks of other sets of tasks. This may include removing a weak dependency by using a rendering technique (e.g., using baked-in local illumination instead of real-time global illumination). In one example, as shown in FIG. 2, the control circuitry may identify the rendering of object set B of FIG. 2 and/or the rendering of object set C of FIG. 2 as the at least one processing task to be performed by a different node(s). The control circuitry may determine the minimum requirement(s) to perform such at least one processing task. For example, the control circuitry may determine that a high-performance node (e.g., having processing capacity exceeding a first processing threshold, and/or a latency measurement that is below a first latency threshold) is required to perform the rendering of object set B of FIG. 2, and/or that a mid-performance node (e.g., having processing capacity exceeding a second threshold, lower than the first threshold, and/or a latency measurement that is below a second latency threshold, higher than the first latency threshold) is sufficient.

At 1306, the control circuitry may identify available nodes. In some embodiments, the control circuitry may reference candidate lists of high-performance nodes, mid-performance nodes, and/or lower-performance nodes. For example, the server (e.g., server 105) may identify nodes within a cloud service network and/or CDN, e.g., client device 108 and server 110 of FIG. 1), or external to the cloud service network. The control circuitry may ping known nodes previously interacted with, to query whether the node has the ability to assist with a processing task, or has its resources tied up with a different processing task, or is otherwise unavailable (e.g., device is turned off or is down). In some embodiments, the hybrid system 100 discovers the potential nodes through a network connection. In some embodiments, the server uses a system management module such as system management module 1022 to assess potential nodes.

In some embodiments, the control circuitry may assign or retrieve trust levels for the identified available nodes, based at least in part on whether the available node is within the same cloud service network as server 105, based on a geographic location of the node, based on a datacenter of the node, and/or based on any other suitable criteria. In some embodiments, certain types of processing tasks (e.g., those involving personal information or sensitive information of the user, such as a credit card number) may be assigned only to trusted nodes, e.g., nodes having been assigned a trust level that exceeds a threshold. In some embodiments, processing tasks that do not involve processing any sensitive information may be eligible to be assigned to nodes having relatively lower trust levels (e.g., below the trust level threshold), or such nodes may not be assigned processing tasks. As an example, the control circuitry may determine that a user is requesting to purchase an item or game updated in a video game and/or VR world, and may prefer the transaction to be handled within a centralized network or cloud service.

At 1308, the control circuitry may determine whether a processing capacity and/or a latency of the node(s) identified at 1306 meets the identified minimum requirements at 1304 for the at least one processing task. For example, the control circuitry may ping or probe the identified node(s) to estimate latency, and/or request or retrieve data related to a processing capacity for the node(s). In some embodiments, the processing capacity comprises a graphics processing capability of the at least one available node, and selecting the client device is based on determining that the graphics processing capability of the client device exceeds a threshold processing capability, and/or based on whether an available node is determined to comprise or have access to a particular model or type of GPU known to have a particular level of processing capacity and/or other parameters. At 1310, the control circuitry may select, based on the identified processing capacities and latencies, at least one available node to perform the at least one processing task related to the media asset, to assist the server in causing the media asset to be displayed at the client device. For example, the control circuitry may select a mid-performance device to perform a simple task such as rendering background elements of a game. In one embodiment the control circuitry avoids assigning tasks to a node with significant latency to prevent delay or ensure synchronization among participating devices.

At 1312, the control circuitry may assign the selected at least one processing task to the selected at least one available node, wherein the at least one processing task creates at least one processing result, and wherein the at least one processing task comprises rendering an interactive 3D object. In the example of FIGS. 1-2, if the control circuitry determines that client device 102 (having requested access to the media asset at 1302) or client device 108 is a high-performance node, one of such client devices may be selected to perform rendering of object set B. As another example, if the control circuitry determines that client device 102 or client device 108 is a mid-performance node, one of such client devices may be selected to perform rendering of object set C. As another example, if the control circuitry determines that server 105 is a high-performance node, server 110 may be assigned to perform rendering of object set B; if the control circuitry determines that server 105 is a mid-performance node, server 110 may be assigned to perform rendering of object set C. In some embodiments, the selected node may be in a same location as server 105 (e.g., in the same datacenter) or in a same location as requesting client device 102 (e.g., within a home network), or may be in a different geographic location (e.g., a different datacenter than server 105, or a different home or business than the home or business of client device 102). In some embodiments, the control circuitry assigns the task via a system management module 1022 which, in some embodiments, sends the assignment to an adaptive rendering module of a node such as 1034. In some embodiments, a processor of a device such as control circuitry 1313 processes the task and creates the result.

In some embodiments, performing the processing task comprises, based at least in part on using a GPU of the selected available node, simulating, rendering, encoding and transmitting over the network (e.g., to client device 102) the processing result, for decoding at client device 102 in a synchronized manner. In some embodiments, selecting such node(s), and/or assigning the processing task to such node(s), may occur at or during a period of time within the media asset of relatively low interactivity, e.g., below a threshold, such as, for example, a cut scene of a video game, or at a menu screen of the video game, which may involve no or minimal user inputs, and less dynamic scene changes than regular gameplay. In some embodiments, the requesting client device 102 may perform a determination of which available nodes to assign which processing tasks to, based at least in part on the computing resources client device 102 has available at the moment.

In some embodiments, the control circuitry may identify a plurality of 3D objects in the media asset (e.g., helicopter 116, weapon 118, fort 120, sky 122, walls 124), and may determine a first subset of such objects (e.g., weapon 118 and helicopter 116 in object set A of FIG. 2) that are likely to interact amongst each other but not likely to interact with a second subset of the plurality of 3D objects (e.g., sky 122 in object set C of FIG. 2, or fort 120 and walls 124 in object set B in FIG. 2). For example, the fort or walls or other landmarks may not show bullet effects even if shot by weapon 118, and thus may be grouped in a separate group, whereas helicopter 116 may be capable of being destroyed by weapon 118's bullets, and thus should be grouped in a same group as helicopter 116. The separate groups of objects may be rendered on respective nodes, as shown in more detail in FIGS. 1-2. For example, server 110 may render object set A and object set B, whereas client device 102 or client device 108 may render object set C.

As another example, the control circuitry may divide the 3D objects into groups based on an amount of time that an object is expected to appear in the media asset. For example, server 105 may send a background environment that is constantly being shown, and the client device 102 may perform rendering and processing of video game characters or other objects of the video game scene. Alternatively, the client device may be configured to render more permanent objects, e.g., a sky, that may not change often, whereas a high-performance server may render objects that appear dynamically for a relatively short amount of time. In some embodiments, the control circuitry may cause the client device 102 or 108 to render the avatar of the video game, and cause server 105 or server 110 to render the background of the video game.

In some embodiments, to enhance system reliability through optimized use of computing resources, the control circuitry may cause the same 3D objects to be rendered on two independent devices, creating redundancy. For example, such redundancy may comprise setting up a backup connection to the server for broadcasting video or an extra connection for mid-performance clients. This setup enables these clients to switch to an alternative stream from another high-performance device that provides the same required viewpoint, should it become necessary. For instance, if one high-performance client device fails, clients dependent on that device for rendering can seamlessly receive content from another high-performance device. This redundancy can also be implemented server-side, or if an insufficient number of powerful client devices exist. In some embodiments, such redundancy technique may prioritize client-side rendering to optimize latency and minimize server load, utilizing server redundancy only when necessary.

In some embodiments, the control circuitry may cause 3D models, e.g., player avatars, non-player characters (NPCs), and/or other dynamic objects, to be rendered on high-performance devices. These models are then shared with mid- or low-performance devices. Simultaneously, other 3D models are downloaded and rendered locally on medium-performance devices. This approach optimizes resource use and improves user experience by utilizing the computational power of more advanced systems to assist devices with lower specifications.

At 1314, the control circuitry may cause the at least one processing result to be merged, at the client device (e.g., client device 102), into a merged processing result corresponding to the media asset. In some embodiments, the processing results from each of the assigned nodes are sent directly to client device 102 of FIG. 1, or via, e.g., server 105, over the network. In some embodiments, at 1316, the control circuitry and/or the I/O circuitry may cause client device 102 to decode and provide for display the merged processing results, based on receiving and decoding video streams from both the server (e.g., server 105) and the strong node client (e.g., server 110 or client device 108). In some embodiments, a low latency P2P connection such as WebRTC may be utilized.

The control circuitry may enable time synchronization when merging the processing results, to ensure the latency relationship between the processing results allows for compositing and reconstructing the frame at the client device.

The disclosed techniques provide for a distributed computing architecture to enhance high-performance gaming and collaborative tasks demanding ultra-low latency, such as, for example, brain surgery simulations or managing complex technological systems. The architecture is built around integrating high-performance, mid-performance, and weak nodes with high-performance servers in the cloud.

In some embodiments, the disclosed techniques provide a hybrid gaming system for enhanced gaming or joint work on 3D objects on mobile devices. This system provides for seamless gameplay of high-performance games and efficient collaboration on 3D projects, demanding ultra-low response times on devices typically underpowered for such intensive activities. This includes non-gaming laptops, tablets, smartphones, and XR devices like the Apple Vision Pro. It aims to minimize GPU/CPU load on servers and reduce Internet bandwidth usage. The innovation centers on an adaptive rendering approach, where the game's environment and short duration dynamic objects may be processed on remote server(s), while the visualization of players and frequently seen dynamic objects are managed directly on the user's device.

In some embodiments, the disclosed techniques facilitate collaborative engagement in high-quality AAA games or joint work on 3D objects among users with medium-spec devices. The system employs a strategic rendering approach to optimize server resources-specifically CPU/GPU usage, energy, and internet bandwidth. The game's environment or major dynamic scene components are rendered server-side and streamed to medium-spec clients. Meanwhile, dynamic objects such as player avatars on high-performance clients may be rendered by these powerful devices and shared with medium-spec clients. Additional dynamic 3D objects, preloaded onto medium-spec devices, may be rendered directly on these devices. Integrating streams from high-performance players and server-side rendering with on-device rendering on medium-spec devices is achieved through CV algorithms, ensuring efficient resource use and smooth collaborative experiences.

In some embodiments, the disclosed techniques minimize internet traffic on the server by distributing 3D models that have already been downloaded from the client's device to other clients when a request for these models is made. The models are transferred directly between client devices using a P2P protocol, with the transfer initiated from the nearest client holding the requested model.

In some embodiments, the disclosed techniques support collaboration in AAA games or on 3D objects for users with low-spec devices while conserving server resources. In this arrangement, dynamic objects—such as avatars controlled by players on high-performance devices—are rendered on these powerful clients and then streamed to the servers. The servers handle rendering the environment and other 3D objects. Additionally, streams from high-performance clients are merged with the server-rendered environments and objects, which are then broadcast to users with low-spec devices. This system ensures that even users with less powerful hardware can participate in demanding gaming or collaborative 3D modeling projects by leveraging server and high-performance client resources for a balanced and efficient rendering distribution.

In some embodiments, the disclosed techniques adaptively select the streaming mode to optimize traffic, processor resources, latency, and response time. Streaming a 3D object view can be done from one or several directions for individual clients, or it can be done as a video to serve many clients, depending on the available resources of a high-performance client device. The device provides personalized single-view streams directly to clients without server involvement if the resources are sufficient. However, if the number of viewers exceeds the device's capacity, it may switch to streaming videos to the server, which then manages the distribution to individual clients. Additionally, suppose the high-performance client device has surplus resources. In that case, it can simultaneously broadcast videos to the server and individual single-view streams to nearby clients, reducing latency by utilizing proximity advantages over the server.

In some embodiments, the disclosed techniques support the joint participation of devices with varying computational capabilities in gaming and collaborative 3D tasks and significantly offload the GPU and CPU demands from servers. This offloading becomes particularly impactful with the increase of low-capability nodes desiring to engage in high-end gaming or intricate 3D collaborations. By harnessing the power of high-capability nodes, even the connection of a single such node can alleviate server load, enhancing overall system efficiency and enabling a high-quality, inclusive experience for a wide range of users. In some embodiments, lower-capability nodes may deliver high-quality content like 4K video streamed from servers and high-capability nodes with the computational power to render AAA games or complex 3D workspaces in real time, leveraging the computational strength of these powerful nodes to render player avatars or specific 3D objects with other players.

In some embodiments, to simultaneously facilitate broadcasting to numerous players, these 3D objects may be captured from multiple angles (including left, right, front, back, and top), creating a comprehensive view. This view may then be encoded using advanced video codecs like VVC or HEVC and transmitted to the server via the QUIC protocol. At the server level, a CV algorithm dynamically generates customized viewpoints for each client and merges them with server-rendered environments and objects. The combined stream is then efficiently delivered to clients in VVC or HEVC format through the WebRTC or QUIC protocols.

The processes discussed above and below are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

1. A method comprising:
receiving, at a server from a client device, a request to access a media asset, wherein the server is configured to perform a first processing task related to causing the media asset to be displayed at the client device;
identifying a processing capacity and a latency associated with at least one available node, wherein the at least one available node is in a different geographic location than the server;
selecting, based on the identified processing capacities and latencies, the at least one available node to perform at least one processing task related to the media asset, to assist the server in causing the media asset to be displayed at the client device;
assigning the selected at least one processing task to the selected at least one available node, wherein the first processing task creates a first processing result and the at least one processing task creates at least one processing result, and wherein the at least one processing task comprises rendering an interactive three-dimensional (3D) object;
causing the first processing result and the at least one processing result to be merged, at the client device, into a merged processing result corresponding to the media asset; and
causing the merged processing result corresponding to the media asset to be displayed on the client device.

2. The method of claim 1, wherein the at least one available node comprises the client device.

3. The method of claim 2, wherein the processing capacity comprises a graphics processing capability of the at least one available node, and selecting the client device is based on determining that the graphics processing capability of the client device exceeds a threshold processing capability.

4. The method of claim 1, wherein the server is a first server, and the at least one available node comprises a second server at the different geographic location than the first server.

5. The method of claim 1, wherein the media asset is a video game, the method further comprising:
determining that a current portion of the video game being provided by the server to the client device is associated with a level of interactivity that is below a threshold; and
based on the determining, performing the assigning of the at least one processing task to the at least one available node during the current portion of the video game associated with the level of interactivity.

6. The method of claim 1, further comprising:
identifying a plurality of 3D portions of the media asset, wherein the plurality of 3D portions comprise at least one of 3D objects or 3D scene elements;
determining a first subset of the plurality of 3D portions are likely to interact amongst each other but not likely to interact with a second subset of the plurality of 3D portions; and
determining that the second subset of the plurality of 3D portions are likely to interact amongst each other but not likely to interact with the first subset of the plurality of 3D portions;
wherein assigning the selected at least one processing task comprises:
causing the at least one node to render the first subset of the plurality of 3D portions to the at least one node; and
rendering, by the server, the second subset of the plurality of 3D portions.

7. The method of claim 1, wherein the at least one available node is the client device, the method further comprising:
identifying a plurality of 3D portions in the media asset, wherein the plurality of 3D portions comprise at least one of 3D objects or 3D scene elements;
determining a first subset of the plurality of 3D portions that appear in the media asset for more than a threshold period of time,
determining a second subset of the plurality of 3D portions that appear in the media asset for less than the threshold period of time; and
wherein assigning the selected at least one processing task comprises:
causing the client device to render the first subset of the plurality of 3D portions; and
rendering, by the server, the second subset of the plurality of 3D portions.

8. The method of claim 1, wherein the at least one available node is the client device, and wherein the media asset is a video game comprising a background and an avatar of a user associated with the client device, wherein assigning the selected at least one processing task comprises:
causing the client device to render the avatar of the video game;
rendering, by the server, the background of the video game.

9. The method of claim 1, wherein:
the rendering of the interactive 3D object is performed at each of a first available node and a second available node of the selected at least one node, to create redundancy with respect to the rendering of the interactive 3D object;
at a first time, the merged processing result comprises the rendering performed by the first available node, the method further comprising:
determining, at a second time, that the first available node is no longer available to perform the rendering; and
based on the determining, causing the merged processing result to include the rendering performed by the second available node.

10. The method of claim 1, wherein the at least one node comprises the client device, the method further comprising:
causing the client device to download a 3D model associated with the media asset; and
causing the client device to transmit the 3D model to another client device accessing the media asset, wherein the processing capacity of the client device is greater than a processing capacity of the other device.

11. The method of claim 1, further comprising:
causing the client device to generate a value indicative of a reference time at the client device;
receiving, at the server, the value, wherein the value is transmitted to the server, and to the at least one available node, based on a user input received at the client device;
embedding, at the server, the value in a first portion of the media asset generated by a processing task performed by the server;
causing the at least one available node to embed the value in a second portion of the media asset generated by the at least one processing task assigned to the at least one available node,
wherein the client device synchronizes display of the first portion and the second portion based on the value embedded in the first and second portions.

12. The method of claim 11, further comprising authenticating each node in the selection of nodes, wherein authenticating each node in the selection of nodes comprises assigning a trust level to each node in the selection of nodes and wherein assigning the at least one processing task is further based on the assigned trust levels.

13. The method of claim 12, wherein the server is associated with a cloud service, and assigning the trust level comprises:
determining whether each of a plurality of nodes is external to the cloud service or is included in the cloud service; and
assigning each node that is external to the network to one or more trust levels that are lower than trust levels of each node that is included in the cloud service.

14. The method of claim 13, further comprising:
determining that the at least one processing task comprises a task related to a sensitive data; and
based on determining that the at least one processing task comprises a processing task related to a sensitive data, causing a node that is included in the network, and having a relatively higher assigned trust level, to perform the processing task related to the sensitive data, instead of a node that is external to the network having a relatively lower assigned trust level.

15. The method of claim 1, further comprising causing one or more of the first processing result or the at least one processing result to be transferred directly between nodes in the selection of nodes.

16. The method of claim 1, further comprising:
identifying a plurality of 3D portions in the media asset, wherein the plurality of 3D portions comprise at least one of 3D objects or 3D scene elements;
determining a first likelihood of a first subset of the plurality of 3D portions to interact with each other;
determining a second likelihood of the first subset of the plurality of 3D portions to interact with a second subset of the plurality of 3D portions, wherein the second likelihood is a non-zero likelihood;
based at least in part on determining that the first likelihood exceeds a threshold and that the second likelihood does not exceed the threshold, maintaining a dependency between the first subset and the second subset and removing a dependency between the first subset and the second subset; and
causing the at least one node to render the first subset of the plurality of 3D portions; and rendering, by the server, the second subset of the plurality of 3D portions.

17. A system comprising:
control circuitry configured to:
receive, at a server from a client device, a request to access a media asset, wherein the server is configured to perform a first processing task related to causing the media asset to be displayed at the client device;
identify a processing capacity and a latency associated with at least one available node, wherein the at least one available node is in a different geographic location than the server;
select, based on the identified processing capacities and latencies, the at least one available node to perform at least one processing task related to the media asset, to assist the server in causing the media asset to be displayed at the client device;
assign the selected at least one processing task to the selected at least one available node, wherein the first processing task creates a first processing result and the at least one processing task creates at least one processing result, and wherein the at least one processing task comprises rendering an interactive three-dimensional (3D) object;
cause the first processing result and the at least one processing result to be merged, at the client device, into a merged processing result corresponding to the media asset; and
cause the merged processing result corresponding to the media asset to be displayed on the client device.

18. The system of claim 17, wherein the at least one available node comprises the client device.

19. The system of claim 18, wherein the processing capacity comprises a graphics processing capability of the at least one available node, and the control circuitry is further configured to select the client device based on determining that the graphics processing capability of the client device exceeds a threshold processing capability.

20. The system of claim 17, wherein the server is a first server, and the at least one available node comprises a second server at the different geographic location than the first server.

21-80. (canceled)
